(19) United States
(12) Patent Application Publication
(10) Pub. No.: US 2026/0254786 A1
(43) Pub. Date: Aug. 27, 2026

(54) SYSTEM

(71) Applicant: SoftBank Group Corp., Tokyo (JP)

(72) Inventor: Hirotaka KITAGAWA, Tokyo (JP)

(73) Assignee: SoftBank Group Corp., Tokyo (JP)

(21) Appl. No.: 19/536,250

(22) Filed: Feb. 11, 2026

(30) Foreign Application Priority Data
Feb. 21, 2025 (JP) 2025-027017

(51) Int. Cl. H04L 51/222; G06F 40/268; G06F 40/30

(52) U.S. Cl. CPC H04L 51/222; G06F 40/268; G06F 40/30

(57) ABSTRACT

The system according to the embodiment comprises a collection unit, an analysis unit, and a verbalization unit. The collection unit collects communication data. The analysis unit analyzes the communication data collected by the collection unit and extracts issues. The verbalization unit verbalizes the issues extracted by the analysis unit.

### CROSS-REFERENCE TO RELATED APPLICATION

The present application claims priority to and incorporates by reference the entire contents of Japanese Patent Application No. 2025-027017 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult to efficiently extract and verbalize issues within an organization.

### SUMMARY OF THE INVENTION

The system according to the embodiment comprises a collection unit, an analysis unit, and a verbalization unit. The collection unit collects communication data. The analysis unit analyzes the communication data collected by the collection unit and extracts issues. The verbalization unit verbalizes the issues extracted by the analysis unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

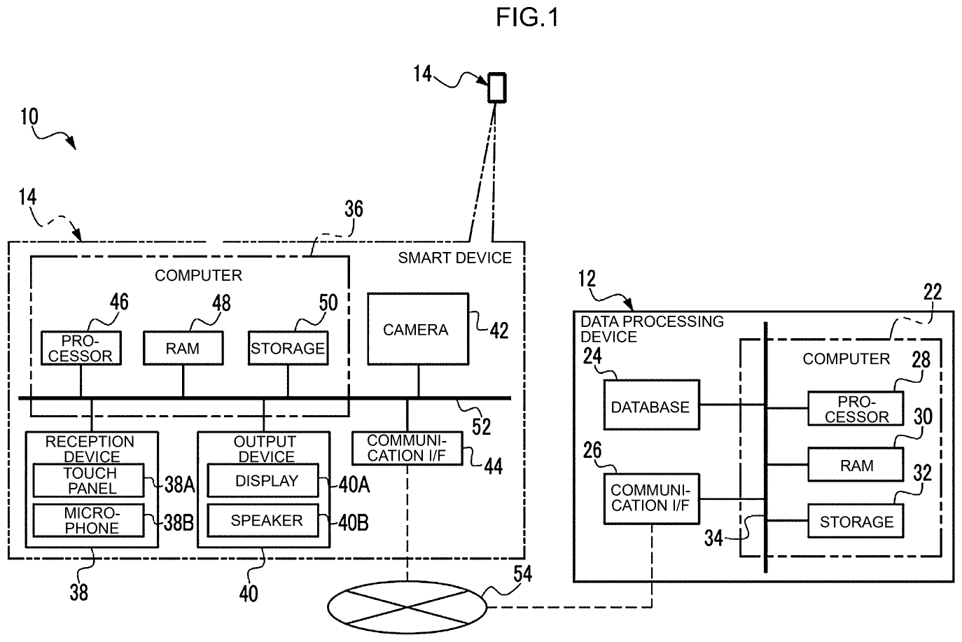

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

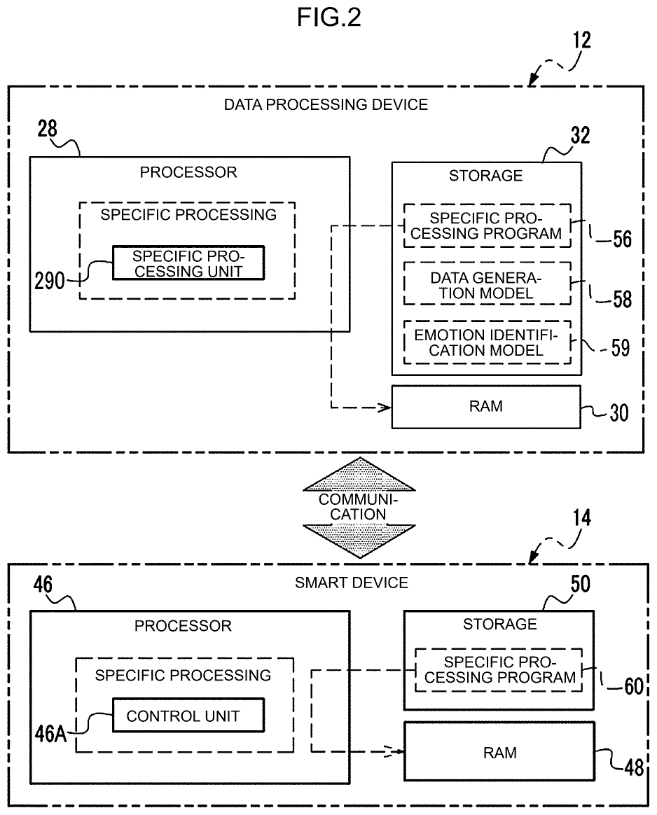

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a tool intended for internal business improvement. This tool is a system that uses generative AI to extract and verbalize issues faced by an organization. For example, communication data such as emails, chats, and call center histories are collected using a communication data collection system. This data collection process is automated by generative AI. Next, the collected data is analyzed by generative AI. The generative AI uses natural language processing technology to analyze text within the data and extract issues. For example, it identifies information useful for business improvement, such as complaints from customers or feedback from employees. The extracted issues are verbalized by generative AI and output as a report. For instance, it generates a report summarizing complaint details from customers or improvement proposals from employees. This tool is intended for use in internal business improvement and for improving the impression of consumer customers, and it can also be deployed to other companies. For example, by introducing it to call centers or customer support departments of other companies, similar business improvement effects can be obtained. As a result, the system can contribute to internal business improvement and enhancement of customer satisfaction. Specifically, the system is composed of multiple modules, with a collection unit, an analysis unit, and a verbalization unit working in cooperation. The system first has the collection unit automatically acquire communication data from multiple data sources such as mail servers, chat servers, and call center record databases. When acquiring data, the collection unit vectorizes the communication data and stores it as structured data (e.g., a four-dimensional vector for emails with sender, recipient, subject, and body as elements). Similarly, chat histories and call center histories are managed as multidimensional arrays including sender, recipient, utterance content, timestamp, etc. The collection unit also automatically performs preprocessing such as duplicate elimination and noise removal to ensure data quality. Next, the analysis unit receives the structured data from the collection unit and inputs it into a natural language processing model (e.g., a Transformer-based large language model). Examples of input include email body text (length: 512 tokens), chat utterance sequences (time series arrays, each utterance: 100 tokens), and call center call records (speech recognition result text, 1000 tokens). The analysis unit applies morphological analysis, grammatical analysis, and semantic analysis in stages to generate features such as key phrase extraction, sentiment analysis, and topic classification. For example, the analysis unit classifies the causes of complaints into categories such as “product defects,” “delayed response,” and “insufficient explanation,” and calculates occurrence frequency and impact scores (continuous values from 0.0 to 1.0) for each category. The output of the analysis unit includes a list of extracted issues (e.g., {‘category’: ‘product defect’, ‘frequency’: 0.35, ‘representative sentence’: ‘The product does not work’}), structured data with importance scores, or summary text for each issue. The verbalization unit receives the output from the analysis unit and inputs it into a report generation model (e.g., an encoder-decoder type generative model). Based on the extracted issue list and summary text, the verbalization unit automatically generates reports in various formats such as bullet points, tables, and narrative summaries. For example, it outputs specific sentences such as “The main causes of customer complaints are product defects (35%), delayed response (20%), and insufficient explanation (15%). Improvement proposals include enhancement of FAQs and revision of response manuals.” The output format can support various formats such as PDF, HTML, and CSV. As a technical effect, the system significantly improves processing speed compared to manual reading of vast communication data by humans, and enables stable generation of highly reproducible business improvement reports by reducing variation in extraction accuracy through high-dimensional feature extraction and automatic classification/summary by AI. Furthermore, by optimizing AI model parameters and algorithms, customization according to specific industries and organizational structures is easy, and rapid adaptation is possible when deployed to other companies. Application fields include call centers, customer support, internal help desks, quality control departments, and even inquiry response operations at medical institutions and public agencies, making it applicable to a wide range of business improvement areas. Examples of AI input/output include input such as “Customer complaint email body (e.g., ‘Your product does not work. I contacted support but the response was slow.’)” or “Feedback from employees (e.g., ‘I would like you to consider introducing a new tool’)”, and output such as “Issue category: delayed response, importance: 0.8” or “Improvement proposal: consider tool introduction” in the form of structured data or summary text. Subsequent processing utilizes these outputs for dashboard display to management, automatic generation of action plans, and linkage with KPI management systems. Unlike conventional manual work or simple rule-based processing, the system realizes improvement of computer technology itself through high-dimensional feature extraction in vector space, nonlinear pattern recognition by deep learning models, and integrated analysis of multiple data sources. This enables full automation and optimization of the information extraction, organization, and report generation process for business improvement, strongly supporting organizational decision-making.

The business improvement system according to the embodiment comprises a collection unit, an analysis unit, and a verbalization unit. The collection unit collects communication data. Communication data may include, for example, emails, chats, and call center histories, but is not limited to these examples. The collection unit may acquire data from internal communication databases, for example. The collection unit can automatically collect necessary information from various data sources using generative AI. For example, the collection unit may acquire email data from a mail server, chat history from a chat application, and call history from a call center system. The analysis unit analyzes the communication data collected by the collection unit using generative AI. The analysis unit uses natural language processing technology to analyze text within the data and extract issues. For example, the analysis unit identifies information useful for business improvement, such as complaints from customers or feedback from employees. The analysis unit can use generative AI to understand the content of the data and extract important information. The verbalization unit verbalizes the issues extracted by the analysis unit using generative AI. The verbalization unit organizes the extracted information in an easily understandable manner and outputs it as a report. For example, the verbalization unit generates a report summarizing complaint details from customers or improvement proposals from employees. As a result, the business improvement system according to the embodiment can contribute to internal business improvement and enhancement of customer satisfaction. Specifically, the business improvement system automatically acquires data from multiple communication data sources (mail servers, chat servers, call center record databases, etc.) via the collection unit, vectorizes the acquired data, and stores it as structured data. For example, email data is stored as a four-dimensional vector with sender, recipient, subject, and body as elements; chat history is managed as a multidimensional array including sender, recipient, utterance content, and timestamp; and call center history is managed as a tensor including speech recognition result text and call duration. The collection unit also automatically performs preprocessing such as duplicate elimination and noise removal to ensure data quality. The analysis unit inputs the structured data received from the collection unit into a natural language processing model such as a Transformer-based large language model. Examples of input include email body text (512 tokens), chat utterance sequences (time series arrays, each utterance: 100 tokens), and call center call records (speech recognition result text, 1000 tokens). The analysis unit applies morphological analysis, grammatical analysis, and semantic analysis in stages to generate features such as key phrase extraction, sentiment analysis, and topic classification. For example, the analysis unit classifies the causes of complaints into categories such as “product defects,” “delayed response,” and “insufficient explanation,” and calculates occurrence frequency and impact scores (continuous values from 0.0 to 1.0) for each category. The output of the analysis unit includes a list of extracted issues (e.g., category: product defect, frequency: 0.35, representative sentence: product does not work), structured data with importance scores, or summary text for each issue. The verbalization unit receives the output from the analysis unit, inputs it into an encoder-decoder type generative model, and automatically generates reports in various formats such as bullet points, tables, and narrative summaries based on the extracted issue list and summary text. For example, it outputs specific sentences such as “The main causes of customer complaints are product defects (35%), delayed response (20%), and insufficient explanation (15%). Improvement proposals include enhancement of FAQs and revision of response manuals.” The output format can support various formats such as PDF, HTML, and CSV. As a technical effect, the business improvement system significantly improves processing speed compared to manual reading of vast communication data by humans, and enables stable generation of highly reproducible business improvement reports by reducing variation in extraction accuracy through high-dimensional feature extraction and automatic classification/summary by AI. Furthermore, by optimizing AI model parameters and algorithms, customization according to specific industries and organizational structures is easy, and rapid adaptation is possible when deployed to other companies. Application fields include call centers, customer support, internal help desks, quality control departments, medical institutions, and public agencies, making it applicable to a wide range of business improvement areas. Examples of AI input/output include input such as customer complaint email body (e.g., “Your product does not work. I contacted support but the response was slow.”) or feedback from employees (e.g., “I would like you to consider introducing a new tool”), and output such as issue category: delayed response, importance: 0.8, improvement proposal: consider tool introduction in the form of structured data or summary text. Subsequent processing utilizes these outputs for dashboard display to management, automatic generation of action plans, and linkage with KPI management systems. Unlike conventional manual work or simple rule-based processing, the business improvement system realizes improvement of computer technology itself through high-dimensional feature extraction in vector space, nonlinear pattern recognition by deep learning models, and integrated analysis of multiple data sources. This enables full automation and optimization of the information collection process for business improvement, strongly supporting organizational decision-making.

The collection unit can collect data of emails, chats, and call center histories. For example, the collection unit acquires email data from a mail server. Email data includes information such as sender, recipient, subject, and body. The collection unit acquires chat history from a chat application. Chat history includes information such as sender, recipient, message content, and transmission date and time. The collection unit acquires call history from a call center system. Call history includes information such as caller, recipient, call content, and call duration. Thus, by collecting diverse communication data, the collection unit can obtain a wide range of information. Some or all of the above-described processing in the collection unit may be performed using generative AI, or may be performed without using generative AI. For example, the collection unit may input email data acquired from a mail server into generative AI, and the generative AI may analyze the email data to extract necessary information. Specifically, the collection unit is implemented by combining technologies such as API integration, batch processing, and event triggers to automatically acquire data from multiple communication data sources (mail servers, chat servers, call center record databases, etc.). The collection unit divides the acquired email data into each element such as sender, recipient, subject, and body, and stores it in the internal database as a four-dimensional vector. Chat history is managed as a multidimensional array including sender, recipient, utterance content, and timestamp, and call center history is saved as tensor data including text results from a speech recognition engine, call duration, and caller/recipient IDs. The collection unit automatically executes preprocessing such as duplicate elimination algorithms (e.g., duplicate detection by hash value) and noise removal processing (e.g., spam filtering, misrecognition removal) at the time of data acquisition to ensure data quality. Furthermore, as preprocessing for inputting the acquired data into generative AI (e.g., Transformer-based large language models), the collection unit performs text normalization (symbol removal, notation unification), tokenization (division into words/sentences), and vectorization (conversion to embedding representations). Examples of AI input include structured data such as “Sender: userA, Recipient: userB, Subject: Regarding delayed delivery, Body: We have received your notice of delayed delivery,” and chat history such as “Sender: agent1, Recipient: customerX, Utterance content: The product has not arrived, Timestamp: 2024-06-01 10:00:00.” Examples of AI output include structured data such as “Importance: 0.9, Category: delayed delivery, Representative sentence: We have received your notice of delayed delivery” and “Sentiment: dissatisfaction, Utterance classification: complaint.” The collection unit builds a data flow via a database or message queue to link these outputs to subsequent analysis and verbalization units. As a technical effect, the collection unit greatly improves the processing speed of data collection compared to manual collection and organization of emails, chats, and call histories by humans, by combining API integration, automatic preprocessing, and AI-based feature extraction, and enhances the comprehensiveness, consistency, and reproducibility of data. Furthermore, by optimizing AI model parameters and preprocessing algorithms, customization according to specific industries and organizational structures is easy, and rapid adaptation is possible when deployed to other companies. Application fields include call centers, customer support, internal help desks, quality control departments, medical institutions, and public agencies, making it applicable to a wide range of business improvement areas. Unlike conventional manual work or simple rule-based processing, the collection unit realizes improvement of computer technology itself through high-dimensional feature extraction in vector space, nonlinear pattern recognition by deep learning models, and integrated analysis of multiple data sources. This enables full automation and optimization of the entire information collection process for business improvement, strongly supporting organizational decision-making.

The analysis unit can analyze text within data using natural language processing technology and extract issues. For example, the analysis unit uses morphological analysis to divide text data into words. Morphological analysis is a technique for analyzing text data and identifying the part of speech and meaning of each word. The analysis unit uses grammatical analysis to analyze the grammatical structure of text data. Grammatical analysis is a technique for analyzing grammatical relationships in text data and identifying sentence structure. The analysis unit uses semantic analysis to analyze the meaning of text data. Semantic analysis is a technique for understanding the meaning of text data and extracting important information. For example, the analysis unit analyzes complaint details from customers to identify the causes and impacts of complaints. The analysis unit also analyzes feedback from employees to identify proposals for business improvement. Thus, by using natural language processing technology, the analysis unit can accurately extract issues within data. Some or all of the above-described processing in the analysis unit may be performed using generative AI, or may be performed without using generative AI. For example, the analysis unit may input text data into generative AI, and the generative AI may analyze the text data to extract issues. Specifically, the analysis unit utilizes natural language processing models such as Transformer-based large language models, BERT, and LSTM, with structured data received from the collection unit (e.g., email body text: 512 tokens, chat utterance sequence: 100 tokens×time series array, call center call record: 1000 tokens) as input. The analysis unit first uses a morphological analysis engine (e.g., MeCab or Juman++) to divide text into words and identify the part of speech (noun, verb, adjective, etc.) and base form of each word. Next, a grammatical analysis module performs dependency parsing and syntax tree generation to clarify the structure of sentences such as subject, predicate, and object. Furthermore, a semantic analysis module calculates semantic relationships of words and context in vector space, and generates features such as key phrase extraction (TF-IDF or Attention weighting), sentiment analysis (probability distribution of positive, negative, neutral), and topic classification (LDA or clustering). For example, for input such as “Your product does not work. I contacted support but the response was slow,” the analysis unit outputs structured data such as “Category: product defect, Cause: malfunction, Impact: customer dissatisfaction, Sentiment: dissatisfaction, Importance: 0.85.” For employee feedback (e.g., “I would like you to consider introducing a new tool”), it generates output such as “Category: business efficiency improvement, Proposal: tool introduction, Feasibility: high, Importance: 0.7.” The analysis unit links these outputs to the subsequent verbalization unit for use in report generation, dashboard display, automatic generation of action plans, and other subsequent processing. As a technical effect, the analysis unit greatly improves processing speed compared to manual reading of vast text data by humans, and enables stable generation of highly reproducible business improvement reports by reducing variation in extraction accuracy through high-dimensional feature extraction and automatic classification/summary by AI. Furthermore, by optimizing AI model parameters and algorithms, customization according to specific industries and organizational structures is easy, and rapid adaptation is possible when deployed to other companies. Application fields include call centers, customer support, internal help desks, quality control departments, medical institutions, and public agencies, making it applicable to a wide range of business improvement areas. Unlike conventional manual work or simple rule-based processing, the analysis unit realizes improvement of computer technology itself through high-dimensional feature extraction in vector space, nonlinear pattern recognition by deep learning models, and integrated analysis of multiple data sources. This enables full automation and optimization of the entire information extraction and organization process for business improvement, strongly supporting organizational decision-making.

The verbalization unit can organize extracted information in an easily understandable manner and output it as a report. For example, the verbalization unit organizes extracted issues in bullet points. Bullet points are a method for organizing information concisely and making it visually easy to understand. The verbalization unit organizes extracted issues using charts and tables. Charts and tables are methods for visually representing information and making it easy to understand. The verbalization unit summarizes extracted issues. Summarization is a method for concisely compiling information and emphasizing important points. For example, the verbalization unit summarizes complaint details from customers and organizes the causes and impacts of complaints. The verbalization unit also summarizes improvement proposals from employees and organizes specific action plans for business improvement. Thus, by organizing issues in an easily understandable manner and outputting them as a report, the verbalization unit is useful for formulating specific action plans for business improvement. Some or all of the above-described processing in the verbalization unit may be performed using generative AI, or may be performed without using generative AI. For example, the verbalization unit may input extracted information into generative AI, and the generative AI may organize the information and generate a report. Specifically, the verbalization unit utilizes encoder-decoder type generative models or large language models, with the issue list, summary text, and structured data with importance scores received from the analysis unit as input. The verbalization unit is equipped with a template engine for automatically converting input data into table or bullet point formats, and organizes extracted issues in expressions such as “Category: product defect, Frequency: 35%, Representative sentence: The product does not work.” Furthermore, the verbalization unit applies summarization algorithms (e.g., extractive summarization, generative summarization) to automatically convert multiple issues into narrative summary sentences such as “The main complaints are product defects (35%), delayed response (20%), and insufficient explanation (15%).” As a chart generation function, it is equipped with a module for visualizing occurrence frequency by category as pie charts or bar graphs, and can output reports in various formats such as PDF, HTML, and CSV. Examples of AI input include structured data such as “Category: delayed response, Importance: 0.8, Representative sentence: Support response is slow” and “Proposal: consider tool introduction, Feasibility: high.” Examples of AI output include summary sentences such as “The main causes of customer complaints are delayed response (20%), product defects (35%), and insufficient explanation (15%). Improvement proposals include enhancement of FAQs and revision of response manuals,” and table data such as “Number of complaints by category” and “List of improvement proposals.” The verbalization unit utilizes these outputs for dashboard display, management reporting materials, and linkage to automatic action plan generation systems as subsequent processing. As a technical effect, the verbalization unit greatly improves the processing speed of report creation compared to manual organization, summarization, and report generation of issues by humans, and enhances consistency, comprehensiveness, and reproducibility of expressions through automatic summarization, format conversion, and chart generation by AI. Furthermore, by optimizing AI model parameters and templates, customization according to specific industries and organizational structures is easy, and rapid adaptation is possible when deployed to other companies. Application fields include call centers, customer support, internal help desks, quality control departments, medical institutions, and public agencies, making it applicable to a wide range of business improvement areas. Unlike conventional manual work or simple rule-based processing, the verbalization unit realizes improvement of computer technology itself through high-dimensional feature extraction in vector space, nonlinear pattern recognition by deep learning models, and integrated analysis of multiple data sources. This enables full automation and optimization of the entire information organization and report generation process for business improvement, strongly supporting organizational decision-making.

The verbalization unit can generate a report summarizing complaint details from customers or improvement proposals from employees. For example, the verbalization unit summarizes complaint details from customers and organizes the causes and impacts of complaints. Complaint details may include, for example, product defects, service delays, dissatisfaction with response, and so on. The verbalization unit analyzes complaint details and identifies common issues. For example, if multiple customers submit complaints about defects in the same product, it is determined that there is a quality issue with that product. The verbalization unit summarizes improvement proposals from employees and organizes specific action plans for business improvement. Improvement proposals may include, for example, streamlining business processes, introducing new tools, and improving team communication. The verbalization unit analyzes improvement proposals and identifies feasible action plans. For example, based on feedback from employees, the introduction of a new tool is considered and its effectiveness is evaluated. Thus, by generating a report summarizing complaint details from customers and improvement proposals from employees, the verbalization unit is useful for formulating specific action plans for business improvement. Some or all of the above-described processing in the verbalization unit may be performed using generative AI, or may be performed without using generative AI. For example, the verbalization unit may input complaint details and improvement proposals into generative AI, and the generative AI may organize the information and generate a report. Specifically, the verbalization unit utilizes encoder-decoder type generative models or large language models, with the list of complaint details and improvement proposals, category classification, importance scores, and other structured data received from the analysis unit as input. The verbalization unit is equipped with an algorithm for aggregating complaint details by category and calculating frequency and impact scores. For example, it automatically generates aggregation tables such as “Product defects: 35 cases, Service delays: 20 cases, Dissatisfaction with response: 15 cases,” and extracts common issues. Next, the verbalization unit applies summarization algorithms to generate narrative summary sentences such as “The main complaints are product defects (35%), service delays (20%), and dissatisfaction with response (15%).” For improvement proposals, it scores feasibility and expected effects for each proposal and automatically extracts action plans such as “Introduction of new tools: high feasibility, expected effect: 20% improvement in business efficiency.” Examples of AI input include structured data such as “Complaint detail: product does not work, Category: product defect, Number of cases: 10” and “Improvement proposal: introduction of chatbot, Expected effect: reduction in response time.” Examples of AI output include summary sentences such as “The main causes of customer complaints are product defects (35%), service delays (20%), and dissatisfaction with response (15%). Improvement proposals include introduction of chatbot, enhancement of FAQs, and revision of response manuals,” and table data such as “Number of complaints by category” and “List of improvement proposals.” The verbalization unit outputs these results as reports in various formats such as PDF, HTML, and CSV, and utilizes them for management reporting materials and linkage to automatic action plan generation systems as subsequent processing. As a technical effect, the verbalization unit greatly improves the processing speed of report creation compared to manual aggregation, summarization, and report generation of complaints and proposals by humans, and enhances consistency, comprehensiveness, and reproducibility of expressions through automatic aggregation, summarization, and format conversion by AI. Furthermore, by optimizing AI model parameters and templates, customization according to specific industries and organizational structures is easy, and rapid adaptation is possible when deployed to other companies. Application fields include call centers, customer support, internal help desks, quality control departments, medical institutions, and public agencies, making it applicable to a wide range of business improvement areas. Unlike conventional manual work or simple rule-based processing, the verbalization unit realizes improvement of computer technology itself through high-dimensional feature extraction in vector space, nonlinear pattern recognition by deep learning models, and integrated analysis of multiple data sources. This enables full automation and optimization of the entire information organization and report generation process for business improvement, strongly supporting organizational decision-making.

The analysis unit can identify at least one of information useful for business improvement from complaints from customers or feedback from employees. For example, the analysis unit analyzes complaint details from customers to identify the causes and impacts of complaints. Complaint details may include, for example, product defects, service delays, dissatisfaction with response, and so on. The analysis unit analyzes complaint details and identifies common issues. For example, if multiple customers submit complaints about defects in the same product, it is determined that there is a quality issue with that product. The analysis unit analyzes feedback from employees to identify proposals for business improvement. Feedback may include, for example, streamlining business processes, introducing new tools, and improving team communication. The analysis unit analyzes feedback and identifies feasible proposals. For example, based on feedback from employees, the introduction of a new tool is considered and its effectiveness is evaluated. Thus, by identifying information useful for business improvement from complaints from customers or feedback from employees, the analysis unit is useful for formulating specific action plans for business improvement. Some or all of the above-described processing in the analysis unit may be performed using generative AI, or may be performed without using generative AI. For example, the analysis unit may input complaint details and feedback into generative AI, and the generative AI may analyze the information to identify information useful for business improvement. Specifically, the analysis unit utilizes natural language processing models such as Transformer-based large language models, BERT, and LSTM, with structured data of complaint details and feedback (e.g., category, importance, representative sentence, occurrence frequency, etc.) received from the collection unit as input. The analysis unit first classifies complaint details by category and applies morphological analysis, grammatical analysis, and semantic analysis in stages to extract features such as cause, impact, and sentiment. For example, if there are multiple complaints such as “The product does not work,” the analysis unit uses clustering algorithms to automatically extract common issues and generate structured data such as “Category: product defect, Number of cases: 10, Representative sentence: The product does not work.” For employee feedback, the analysis unit scores feasibility and expected effects for each proposal and outputs data such as “Proposal: introduction of new tool, Feasibility: high, Expected effect: 20% improvement in business efficiency.” Examples of AI input include “Complaint detail: support response is slow, Category: delayed response, Number of cases: 5” and “Feedback: I would like more frequent team meetings, Category: communication improvement.” Examples of AI output include “Category: delayed response, Cause: insufficient support system, Impact: decreased customer satisfaction, Importance: 0.8” and “Proposal: increase meeting frequency, Feasibility: medium, Expected effect: improved information sharing.” The analysis unit links these outputs to the subsequent verbalization unit for use in report generation and automatic action plan generation. As a technical effect, the analysis unit greatly improves processing speed compared to manual analysis, classification, and summarization of complaints and feedback by humans, and enables stable generation of highly reproducible business improvement reports by reducing variation in extraction accuracy through automatic classification, feature extraction, and scoring by AI. Furthermore, by optimizing AI model parameters and algorithms, customization according to specific industries and organizational structures is easy, and rapid adaptation is possible when deployed to other companies. Application fields include call centers, customer support, internal help desks, quality control departments, medical institutions, and public agencies, making it applicable to a wide range of business improvement areas. Unlike conventional manual work or simple rule-based processing, the analysis unit realizes improvement of computer technology itself through high-dimensional feature extraction in vector space, nonlinear pattern recognition by deep learning models, and integrated analysis of multiple data sources. This enables full automation and optimization of the entire information extraction and organization process for business improvement, strongly supporting organizational decision-making.

The collection unit can estimate a user's emotion and adjust the timing of communication data collection based on the estimated emotion of the user. For example, if the user is feeling stressed, the collection unit reduces the frequency of communication data collection to alleviate the burden. If the user is relaxed, the collection unit increases the frequency of communication data collection to collect more detailed data. If the user is in a hurry, the collection unit can temporarily suspend data collection and resume it later. Thus, by adjusting the timing of communication data collection according to the user's emotion, the collection unit can reduce the user's burden and enable efficient data collection. Emotion estimation is realized using, for example, an emotion engine or generative AI with emotion estimation functionality. Generative AI may be, for example, a text generation AI (such as an LLM) or a multimodal generative AI, but is not limited to these examples. Some or all of the above-described processing in the collection unit may be performed using generative AI, or may be performed without using generative AI. For example, the collection unit may input the user's emotion data into generative AI, and the generative AI may analyze the emotion data to adjust the collection timing. Specifically, the collection unit uses the user's communication data (e.g., email body, chat utterance, speech recognition text) and biometric information (e.g., keystroke interval, mouse operation speed, heart rate, skin conductance from wearable devices) as multidimensional vectors (e.g., text: 512 tokens+biometric sensor values: 10 dimensions) for input data. The collection unit inputs these data into a Transformer-based large language model or multimodal neural network, and outputs emotion classification (e.g., stress, relaxation, tension, hurry), emotion intensity score (continuous value from 0.0 to 1.0), and time-series patterns of emotion changes (e.g., stress level trend over the past 30 minutes). Examples of input include “Email body: ‘I am anxious about the delayed delivery,’ Heart rate: 95 bpm, Skin conductance: high” and “Chat utterance: ‘I have plenty of time today,’ Keystroke interval: long.” Examples of AI output include “Emotion label: stress, Intensity: 0.85” and “Emotion label: relaxation, Intensity: 0.3.” Based on these outputs, the collection timing control module automatically adjusts timing using rule-based or reinforcement learning algorithms, such as “If stress intensity is 0.7 or higher, extend collection interval from 10 minutes to 30 minutes,” “If relaxation intensity is 0.5 or higher, shorten collection interval to 5 minutes,” and “If in a hurry (keyword detection such as ‘urgent’ in chat utterance), temporarily suspend collection.” In subsequent processing, the adjusted collection timing is reflected in the scheduler and used for database recording and administrator notification. As a technical effect, the collection unit can estimate the user's psychological burden in real time and efficiently collect necessary and sufficient data without impairing user experience, compared to conventional fixed-interval collection methods, through high-dimensional feature extraction and automatic control by AI. This enables both comprehensiveness of data collection and user satisfaction, contributing to business improvement and enhancement of customer response quality. Application fields include operator load management in call centers, patient stress monitoring in medical settings, work status monitoring for remote workers, and concentration estimation for students in educational settings, making it deployable to various user state-adaptive data collection systems. The present invention realizes improvement of computer technology itself by combining multivariate analysis, nonlinear pattern recognition, and autonomous control by AI, unlike human subjective judgment or simple time control. This enables full automation and optimization of the entire data collection process, strongly supporting organizational decision-making and service quality improvement.

The collection unit can analyze a user's past communication data collection history and select an optimal collection method. For example, the collection unit preferentially selects communication data collection methods that the user has frequently used in the past. The collection unit can select the most efficient collection method based on the user's past communication data collection history. The collection unit can analyze the user's past communication data collection history and select the optimal collection timing. Thus, by analyzing the user's past communication data collection history, the collection unit can select the optimal collection method and enable efficient data collection. Some or all of the above-described processing in the collection unit may be performed using generative AI, or may be performed without using generative AI. For example, the collection unit may input the user's past communication data collection history into generative AI, and the generative AI may analyze the history to select the optimal collection method. Specifically, the collection unit manages each user's past communication data collection history (e.g., collection date and time, collection method type, collected data type, collection success rate, time required for collection, user response, etc.) as a time-series database. The collection unit inputs these history data as time-series arrays (e.g., each history record as a 20-dimensional vector, array of past 100 records) into recurrent neural networks (e.g., LSTM, GRU) or time-series analysis models (e.g., autoregressive models, time-series clustering). Examples of AI input include “History: 2024-06-01 10:00 Email automatic collection Success, 2024-06-01 12:00 Chat manual collection Failure, 2024-06-02 09:00 Call center automatic collection Success.” Examples of AI output include “Recommended collection method: Email automatic collection, Recommended timing: Morning, Expected success rate: 0.95” and “Recommended collection method: Chat automatic collection, Recommended timing: After business hours.” Based on the AI output, the collection method selection module applies rules such as “Prioritize methods with high past success rates,” “Recommend automatic collection if the user dislikes manual collection,” and “Optimize for specific days of the week and times,” and automatically adjusts the collection schedule and method. In subsequent processing, the selected collection method and timing are reflected in the collection job scheduler and used for database recording and administrator report generation. As a technical effect, the collection unit autonomously determines the optimal collection strategy by analyzing each user's behavioral patterns and past collection performance with AI, greatly improving data collection efficiency, success rate, and user satisfaction compared to conventional uniform collection methods. Application fields include optimization of call center call record collection, optimization of patient data collection timing in medical settings, efficient collection of IoT sensor data, and collection of work logs for remote workers, making it deployable to various history-adaptive data collection systems. The present invention realizes improvement of computer technology itself by combining high-dimensional history analysis, pattern extraction, and autonomous optimization by AI, unlike human heuristics or simple scheduling. This enables full automation and optimization of the entire data collection process, strongly supporting operational efficiency and data quality improvement for organizations.

The collection unit can perform filtering based on the user's current project or area of interest when collecting communication data. For example, the collection unit preferentially collects communication data related to the project the user is currently working on. The collection unit can filter and collect communication data related to the user's area of interest. The collection unit can collect necessary communication data according to the progress of the user's current project. Thus, by performing filtering based on the user's current project or area of interest, the collection unit can efficiently collect highly relevant data. Some or all of the above-described processing in the collection unit may be performed using generative AI, or may be performed without using generative AI. For example, the collection unit may input the user's project information or area of interest into generative AI, and the generative AI may analyze the information and perform filtering. Specifically, the collection unit manages the user's project information (e.g., project name, progress status, related keywords, start date, expected end date) and area of interest (e.g., technical field, business category, topic list) as structured data (e.g., project attributes: 10 dimensions+area of interest vector: 20 dimensions). The collection unit inputs metadata of communication data (e.g., subject, body, utterance content, tags, transmission date and time) into a natural language processing model (e.g., Transformer-based large language model) and calculates relevance scores (continuous values from 0.0 to 1.0) with the project or area of interest. Examples of AI input include “Project: AI implementation, Progress: in design, Area of interest: natural language processing, Communication data: ‘Proposal for a new NLP model’” and “Project: quality control, Area of interest: defect analysis, Communication data: ‘Product defect report.’” Examples of AI output include “Relevance score: 0.92, Filtering result: collect” and “Relevance score: 0.35, Filtering result: do not collect.” Based on the AI output, the collection unit collects only communication data with relevance scores above a threshold (e.g., 0.7), and dynamically changes filtering rules according to project progress (e.g., prioritize design-related data during the design phase, prioritize operation-related data during the operation phase). In subsequent processing, filtered data is linked to the analysis and verbalization units and used for project management dashboards and business improvement report generation. As a technical effect, the collection unit efficiently collects only highly relevant data according to the user's work status and interests, greatly reducing data noise and redundancy compared to conventional comprehensive collection methods, and improving the accuracy and efficiency of analysis and report generation. Application fields include project management systems, information collection in R&D environments, customer response history management in sales activities, and adaptive data collection for learning progress in educational settings, making it deployable to various business-adaptive data collection systems. The present invention realizes improvement of computer technology itself by combining high-dimensional feature extraction, semantic relevance estimation, and dynamic rule application by AI, unlike manual data selection or simple keyword matching by humans. This enables full automation and optimization of the entire data collection process, strongly promoting organizational work efficiency and decision-making support.

The collection unit can estimate a user's emotion and determine the priority of communication data to be collected based on the estimated emotion of the user. For example, if the user is feeling stressed, the collection unit preferentially collects communication data with high importance. If the user is relaxed, the collection unit preferentially collects detailed communication data. If the user is in a hurry, the collection unit preferentially collects communication data that can be collected quickly. Thus, by determining the priority of communication data to be collected according to the user's emotion, the collection unit can preferentially collect important data. Emotion estimation is realized using, for example, an emotion engine or generative AI with emotion estimation functionality. Generative AI may be, for example, a text generation AI (such as an LLM) or a multimodal generative AI, but is not limited to these examples. Some or all of the above-described processing in the collection unit may be performed using generative AI, or may be performed without using generative AI. For example, the collection unit may input the user's emotion data into generative AI, and the generative AI may analyze the emotion data to determine the priority of communication data to be collected. Specifically, the collection unit uses communication data (e.g., email body, chat utterance, speech recognition text) and biometric information (e.g., keystroke interval, mouse operation speed, heart rate, skin conductance, etc.) as multidimensional vectors (e.g., text: 512 tokens+biometric sensor values: 10 dimensions) for input data. The collection unit inputs these data into a Transformer-based large language model or multimodal neural network, and outputs emotion classification (e.g., stress, relaxation, tension, hurry), emotion intensity score (continuous value from 0.0 to 1.0), and time-series patterns of emotion changes (e.g., stress level trend over the past 30 minutes). Examples of input include “Email body: ‘I am anxious about the delayed delivery,’ Heart rate: 95 bpm, Skin conductance: high” and “Chat utterance: ‘I have plenty of time today,’ Keystroke interval: long.” Examples of AI output include “Emotion label: stress, Intensity: 0.85” and “Emotion label: relaxation, Intensity: 0.3.” Based on these outputs, the priority determination module automatically adjusts priorities using rule-based or reinforcement learning algorithms, such as “If stress intensity is 0.7 or higher, prioritize communication data with importance score of 0.8 or higher,” “If relaxation intensity is 0.5 or higher, prioritize communication data with detail score of 0.5 or higher,” and “If in a hurry (keyword detection such as ‘urgent’ in chat utterance), prioritize data with short collection time.” In subsequent processing, the determined priority is reflected in the collection scheduler and used for database recording and administrator notification. As a technical effect, the collection unit can estimate the user's psychological state in real time and efficiently collect important data without impairing user experience, compared to conventional fixed collection order methods, through high-dimensional feature extraction and automatic priority control by AI. This enables both comprehensiveness of data collection and user satisfaction, contributing to business improvement and enhancement of customer response quality. Application fields include operator load management in call centers, patient stress monitoring in medical settings, work status monitoring for remote workers, and concentration estimation for students in educational settings, making it deployable to various user state-adaptive data collection systems. The present invention realizes improvement of computer technology itself by combining multivariate analysis, nonlinear pattern recognition, and autonomous control by AI, unlike human subjective judgment or simple prioritization. This enables full automation and optimization of the entire data collection process, strongly supporting organizational decision-making and service quality improvement.

The collection unit can preferentially collect highly relevant data based on the user's geographic location information when collecting communication data. For example, if the user is in a specific region, the collection unit preferentially collects communication data related to that region. The collection unit can filter and collect highly relevant communication data based on the user's geographic location information. If the user is moving, the collection unit can preferentially collect communication data related to the current location. Thus, by preferentially collecting highly relevant data based on the user's geographic location information, the collection unit enables efficient data collection. Some or all of the above-described processing in the collection unit may be performed using generative AI, or may be performed without using generative AI. For example, the collection unit may input the user's geographic location information into generative AI, and the generative AI may analyze the information to preferentially collect highly relevant data. Specifically, the collection unit acquires the user's geographic location information (e.g., GPS coordinates, Wi-Fi access point information, base station ID) as a three-dimensional vector (latitude, longitude, altitude) or time-series array (movement history), and manages it in combination with metadata of communication data (e.g., sender/recipient region, place names in content, tags). The collection unit inputs these data into a Transformer-based large language model or geospatial information processing module, and outputs geographic relevance scores (continuous value from 0.0 to 1.0) and priority labels (high, medium, low). Examples of input include “Current location: Chiyoda-ku, Tokyo, Communication data: ‘About the meeting at the Tokyo branch’” and “Current location: Osaka City, Communication data: ‘Customer support in the Kansai area.’” Examples of AI output include “Relevance score: 0.95, Priority: high” and “Relevance score: 0.40, Priority: low.” Based on the AI output, the collection unit preferentially collects only communication data with relevance scores above a threshold (e.g., 0.7), and dynamically extracts data related to the destination region when the user is moving. In subsequent processing, preferentially collected data is linked to the analysis and verbalization units and used for region-specific reports and local response plan generation. As a technical effect, the collection unit efficiently collects only highly relevant data according to the user's current location and movement history, greatly reducing data noise and redundancy compared to conventional comprehensive collection methods, and improving the accuracy and efficiency of analysis and report generation. Application fields include region-specific customer response history management in sales activities, location-linked work support for field workers, local information collection during disasters, and delivery status monitoring in logistics, making it deployable to various geographic information-adaptive data collection systems. The present invention realizes improvement of computer technology itself by combining high-dimensional feature extraction, semantic relevance estimation, and dynamic rule application by AI, unlike manual data selection or simple place name matching by humans. This enables full automation and optimization of the entire data collection process, strongly promoting organizational work efficiency and decision-making support.

The collection unit can analyze the user's social media activity when collecting communication data and collect relevant data. For example, the collection unit preferentially collects communication data related to topics mentioned by the user on social media. The collection unit can analyze the user's social media activity and filter and collect relevant communication data. The collection unit can preferentially collect communication data related to accounts followed by the user on social media. Thus, by analyzing the user's social media activity, the collection unit can efficiently collect relevant data. Some or all of the above-described processing in the collection unit may be performed using generative AI, or may be performed without using generative AI. For example, the collection unit may input the user's social media activity data into generative AI, and the generative AI may analyze the information and collect relevant data. Specifically, the collection unit manages the user's social media activity data (e.g., post content, like history, followed accounts, retweet/share history) as structured data (e.g., post text: 512 tokens, account ID list, topic vector: 100 dimensions). The collection unit inputs these data into a Transformer-based large language model or graph neural network, and outputs relevance scores (continuous value from 0.0 to 1.0), related topic labels, and priority labels for the metadata and content of communication data (e.g., emails, chats, call records). Examples of input include “Post content: ‘Latest trends in AI technology,’ Followed account: NLP researcher,” and “Communication data: ‘Proposal for a natural language processing model.’” Examples of AI output include “Relevance score: 0.88, Topic: natural language processing, Priority: high” and “Relevance score: 0.45, Topic: image recognition, Priority: low.” Based on the AI output, the collection unit preferentially collects only communication data with relevance scores above a threshold (e.g., 0.7), and dynamically extracts communication data related to accounts followed by the user. In subsequent processing, preferentially collected data is linked to the analysis and verbalization units and used for topic-specific reports and individual response plan generation. As a technical effect, the collection unit efficiently collects only highly relevant data according to the user's interests and network structure, greatly reducing data noise and redundancy compared to conventional comprehensive collection methods, and improving the accuracy and efficiency of analysis and report generation. Application fields include trend analysis in marketing activities, enhancement of individual response in customer support, information collection in R&D environments, and adaptive data collection for learning progress in educational settings, making it deployable to various social media-adaptive data collection systems. The present invention realizes improvement of computer technology itself by combining high-dimensional feature extraction, semantic relevance estimation, and dynamic rule application by AI, unlike manual data selection or simple keyword matching by humans. This enables full automation and optimization of the entire data collection process, strongly promoting organizational work efficiency and decision-making support.

The analysis unit can estimate a user's emotion and adjust the manner of analysis expression based on the estimated emotion of the user. For example, if the user is feeling stressed, the analysis unit provides simple and easy-to-understand analysis results. If the user is relaxed, the analysis unit can provide detailed analysis results. If the user is in a hurry, the analysis unit can provide concise analysis results focusing on key points. Thus, by adjusting the manner of analysis expression according to the user's emotion, the analysis unit can provide analysis results that are easy for the user to understand. Emotion estimation is realized using, for example, an emotion engine or generative AI with emotion estimation functionality. Generative AI may be, for example, a text generation AI (such as an LLM) or a multimodal generative AI, but is not limited to these examples. Some or all of the above-described processing in the analysis unit may be performed using generative AI, or may be performed without using generative AI. For example, the analysis unit may input the user's emotion data into generative AI, and the generative AI may analyze the emotion data to adjust the manner of analysis expression. Specifically, the analysis unit uses communication data (e.g., email body, chat utterance, speech recognition text) and biometric information (e.g., keystroke interval, mouse operation speed, heart rate, skin conductance, etc.) as multidimensional vectors (e.g., text: 512 tokens+biometric sensor values: 10 dimensions) for input data. The analysis unit inputs these data into a Transformer-based large language model or multimodal neural network, and outputs emotion classification (e.g., stress, relaxation, tension, hurry), emotion intensity score (continuous value from 0.0 to 1.0), and time-series patterns of emotion changes. Examples of input include “Email body: ‘I am anxious about the delayed delivery,’ Heart rate: 95 bpm, Skin conductance: high” and “Chat utterance: ‘I have plenty of time today,’ Keystroke interval: long.” Examples of AI output include “Emotion label: stress, Intensity: 0.85” and “Emotion label: relaxation, Intensity: 0.3.” Based on these outputs, the expression adjustment module automatically adjusts the manner of analysis expression using rule-based or reinforcement learning algorithms, such as “If stress intensity is 0.7 or higher, increase summarization rate and output in bullet points or short sentences,” “If relaxation intensity is 0.5 or higher, add detailed explanations and charts,” and “If in a hurry, extract only key points and output in shortened expressions.” In subsequent processing, the adjusted analysis results are used for verbalization, dashboard display, automatic action plan generation, and other purposes. As a technical effect, the analysis unit can automatically optimize the manner of analysis expression according to the user's psychological state, greatly improving user satisfaction and understanding compared to conventional uniform output methods. Application fields include operator support in call centers, generation of explanation materials for patients in medical settings, work status feedback for remote workers, and generation of analysis reports for students in educational settings, making it deployable to various user state-adaptive analysis systems. The present invention realizes improvement of computer technology itself by combining multivariate analysis, nonlinear pattern recognition, and autonomous expression optimization by AI, unlike human subjective judgment or simple template output. This enables full automation and optimization of the entire analysis process, strongly supporting organizational decision-making and service quality improvement.

The analysis unit can adjust the level of detail of analysis based on the importance of the communication data during analysis. For example, the analysis unit performs detailed analysis for communication data with high importance. For communication data with low importance, the analysis unit can perform simplified analysis. The analysis unit can adjust the level of detail of analysis in stages according to importance. Thus, by adjusting the level of detail of analysis based on the importance of the communication data, the analysis unit enables efficient analysis. Some or all of the above-described processing in the analysis unit may be performed using generative AI, or may be performed without using generative AI. For example, the analysis unit may input communication data into generative AI, and the generative AI may analyze the importance of the data and adjust the level of detail. Specifically, the analysis unit manages communication data received from the collection unit (e.g., email body, chat utterance, call center call record) as structured data (e.g., sender, recipient, subject, body, timestamp, importance score, etc., as a 10-dimensional vector). For data with high importance scores (e.g., continuous value from 0.0 to 1.0), the analysis unit applies a detailed analysis pipeline using natural language processing models such as Transformer-based large language models, BERT, and LSTM, including morphological analysis, grammatical analysis, semantic analysis, sentiment analysis, topic classification, causal relationship extraction, and summary generation. For example, for a complaint email with importance 0.9 (e.g., “Your product does not work. The support response is also slow.”), the analysis unit outputs multi-item structured data such as “Category: product defect, Cause: malfunction, Impact: customer dissatisfaction, Sentiment: dissatisfaction, Importance: 0.9, Detailed summary: Review of support system is necessary.” On the other hand, for data with low importance (e.g., importance 0.2 for a routine notification email), the analysis unit applies only morphological analysis and simple topic classification, and outputs simplified results such as “Category: general notification, Importance: 0.2, Summary: No special notes.” The analysis unit controls branching of the analysis pipeline according to the importance score, optimizing allocation of computational resources and balancing processing load. Examples of AI input include “Email body: ‘I am anxious about the delayed delivery,’ Importance: 0.85” and “Chat utterance: ‘I have plenty of time today,’ Importance: 0.3.” Examples of AI output include “Category: delayed delivery, Sentiment: anxiety, Detailed summary: Recommend review of delivery management process” and “Category: casual conversation, Summary: No special notes.” In subsequent processing, detailed analysis results are linked to the verbalization unit and used for management reports, automatic action plan generation, and input to KPI management systems. As a technical effect, the analysis unit can automatically adjust the level of detail of analysis according to the importance of the communication data, enabling efficient use of computational resources, improved processing speed, prevention of overlooking important information, and uniform report quality compared to conventional uniform analysis methods. Furthermore, by optimizing AI model parameters and branching algorithms, flexible adaptation to operational requirements for each industry and organization is possible, and rapid adaptation is possible when deployed to other companies. Application fields include complaint analysis in call centers, anomaly detection in quality control departments, urgency assessment in medical settings, and risk information extraction in financial institutions, making it deployable to various business areas requiring importance-adaptive analysis optimization. The present invention realizes improvement of computer technology itself by combining high-dimensional feature extraction, nonlinear pattern recognition, and autonomous branching control by AI, unlike human subjective judgment or simple uniform processing. This enables full automation and optimization of the entire analysis process, strongly supporting organizational decision-making and service quality improvement.

The analysis unit can apply different analysis algorithms according to the category of the communication data during analysis. For example, the analysis unit applies a specific analysis algorithm to complaint data from customers. The analysis unit can apply a different analysis algorithm to feedback data from employees. The analysis unit can select and apply the optimal analysis algorithm according to the category of the communication data. Thus, by applying different analysis algorithms according to the category of the communication data, the analysis unit can provide optimal analysis results. Some or all of the above-described processing in the analysis unit may be performed using generative AI, or may be performed without using generative AI. For example, the analysis unit may input communication data into generative AI, and the generative AI may analyze the category of the data and apply the optimal algorithm. Specifically, the analysis unit manages communication data received from the collection unit (e.g., email body, chat utterance, call center call record) as structured data including category attributes (e.g., complaint, feedback, general notification, technical consultation) (category label+body text+metadata, etc.). The analysis unit is equipped with a control module for automatically selecting different analysis algorithms for each category. For example, for complaint data (category: complaint), the analysis unit combines a Transformer-based large language model, sentiment analysis module, and causal relationship extraction algorithm (e.g., Attention weighting+causal graph generation) to extract multidimensional features such as “cause,” “impact,” “sentiment,” and “improvement proposal.” For employee feedback (category: feedback), the analysis unit applies time-series models such as LSTM or GRU and summary generation algorithms (e.g., extractive summarization, generative summarization) to extract features such as “proposal content,” “feasibility,” and “expected effect.” Examples of AI input include “Category: complaint, Body: ‘The product does not work’” and “Category: feedback, Body: ‘I would like you to consider introducing a new tool.’” Examples of AI output include “Category: complaint, Cause: malfunction, Sentiment: dissatisfaction, Improvement proposal: strengthen support system” and “Category: feedback, Proposal content: tool introduction, Feasibility: high, Expected effect: 20% improvement in business efficiency.” By branching the analysis pipeline for each category, the analysis unit optimizes allocation of computational resources and improves analysis accuracy. In subsequent processing, category-specific analysis results are used for verbalization, dashboard display, automatic action plan generation, and other purposes. As a technical effect, the analysis unit can automatically apply the optimal analysis algorithm according to the category of the communication data, greatly improving analysis accuracy, speed, and flexibility compared to conventional uniform analysis methods. Furthermore, by optimizing AI model parameters and algorithm selection rules, flexible adaptation to operational requirements for each industry and organization is possible, and rapid adaptation is possible when deployed to other companies. Application fields include complaint analysis in call centers, feedback aggregation in internal help desks, anomaly detection in quality control departments, and case classification in medical settings, making it deployable to various business areas requiring category-adaptive analysis. The present invention realizes improvement of computer technology itself by combining high-dimensional feature extraction, nonlinear pattern recognition, and autonomous algorithm selection by AI, unlike human heuristics or simple uniform processing. This enables full automation and optimization of the entire analysis process, strongly supporting organizational decision-making and service quality improvement.

The analysis unit can estimate a user's emotion and adjust the length of analysis based on the estimated emotion of the user. For example, if the user is feeling stressed, the analysis unit provides concise analysis results focusing on key points. If the user is relaxed, the analysis unit can provide detailed analysis results. If the user is in a hurry, the analysis unit can summarize the analysis results concisely for quick understanding. Thus, by adjusting the length of analysis according to the user's emotion, the analysis unit can provide analysis results that are easy for the user to understand. Emotion estimation is realized using, for example, an emotion engine or generative AI with emotion estimation functionality. Generative AI may be, for example, a text generation AI (such as an LLM) or a multimodal generative AI, but is not limited to these examples. Some or all of the above-described processing in the analysis unit may be performed using generative AI, or may be performed without using generative AI. For example, the analysis unit may input the user's emotion data into generative AI, and the generative AI may analyze the emotion data to adjust the length of analysis. Specifically, the analysis unit uses communication data (e.g., email body, chat utterance, speech recognition text) and biometric information (e.g., keystroke interval, mouse operation speed, heart rate, skin conductance, etc.) as multidimensional vectors (e.g., text: 512 tokens+biometric sensor values: 10 dimensions) for input data. The analysis unit inputs these data into a Transformer-based large language model or multimodal neural network, and outputs emotion classification (e.g., stress, relaxation, tension, hurry), emotion intensity score (continuous value from 0.0 to 1.0), and time-series patterns of emotion changes. Examples of input include “Email body: ‘I am anxious about the delayed delivery,’ Heart rate: 95 bpm, Skin conductance: high” and “Chat utterance: ‘I have plenty of time today,’ Keystroke interval: long.” Examples of AI output include “Emotion label: stress, Intensity: 0.85” and “Emotion label: relaxation, Intensity: 0.3.” Based on these outputs, the analysis length adjustment module automatically adjusts the length of analysis using rule-based or reinforcement learning algorithms, such as “If stress intensity is 0.7 or higher, increase summarization rate and output in bullet points or short sentences,” “If relaxation intensity is 0.5 or higher, add detailed explanations and charts,” and “If in a hurry, extract only key points and output in shortened expressions.” For example, for a user in a stress state, the analysis unit outputs a short summary such as “Main issue: delayed delivery. Improvement proposal: strengthen delivery management.” For a user in a relaxed state, the analysis unit outputs a detailed explanation such as “The background of the delayed delivery is a deficiency in process management, and there is a high risk of recurrence based on trends over the past three months. As improvement measures, reviewing the process and introducing progress management tools are effective.” In subsequent processing, the adjusted analysis results are used for verbalization, dashboard display, automatic action plan generation, and other purposes. As a technical effect, the analysis unit can automatically optimize the length of analysis according to the user's psychological state, greatly improving user satisfaction and understanding compared to conventional uniform output methods. Application fields include operator support in call centers, generation of explanation materials for patients in medical settings, work status feedback for remote workers, and generation of analysis reports for students in educational settings, making it deployable to various user state-adaptive analysis systems. The present invention realizes improvement of computer technology itself by combining multivariate analysis, nonlinear pattern recognition, and autonomous expression optimization by AI, unlike human subjective judgment or simple template output. This enables full automation and optimization of the entire analysis process, strongly supporting organizational decision-making and service quality improvement.

The analysis unit can determine the priority of analysis based on the submission timing of the communication data during analysis. For example, the analysis unit preferentially analyzes the latest communication data. The analysis unit can postpone analysis of older communication data. The analysis unit can adjust the priority of analysis in stages according to submission timing. Thus, by determining the priority of analysis based on the submission timing of the communication data, the analysis unit enables efficient analysis. Some or all of the above-described processing in the analysis unit may be performed using generative AI, or may be performed without using generative AI. For example, the analysis unit may input communication data into generative AI, and the generative AI may analyze the submission timing of the data and determine the priority. Specifically, the analysis unit assigns submission time or timestamp (e.g., ISO8601 format date-time string) to communication data received from the collection unit and manages it as a time-series database. The analysis unit inputs structured data including submission timing information (e.g., body text+submission time+importance+category) into the priority determination module. The priority determination module preferentially analyzes the latest data (e.g., within one hour of submission) and postpones analysis of older data (e.g., more than one day old) using rule-based control or dynamic priority scoring by time-series analysis models (e.g., LSTM, autoregressive models). Examples of AI input include “Body: ‘Urgent response required,’ Submission time: 2024-06-01T10: 00:00” and “Body: ‘This is a regular report,’ Submission time: 2024-05-28T09: 00:00.” Examples of AI output include “Priority: high, Analysis order: 1” and “Priority: low, Analysis order: 10.” The analysis unit controls the analysis job scheduler based on priority, optimizing allocation of computational resources and ensuring real-time processing. In subsequent processing, prioritized analysis results are used for verbalization, dashboard display, automatic action plan generation, and other purposes. As a technical effect, the analysis unit can automatically determine the priority of analysis based on the submission timing of the communication data, enabling rapid processing of urgent information, prevention of business delays, and improved analysis efficiency compared to conventional FIFO or manual assignment methods. Furthermore, by optimizing AI model parameters and priority determination algorithms, flexible adaptation to operational requirements for each industry and organization is possible, and rapid adaptation is possible when deployed to other companies. Application fields include urgent complaint response in call centers, emergency case analysis in medical settings, and priority processing of risk information in financial institutions, making it deployable to various business areas requiring time-series priority control. The present invention realizes improvement of computer technology itself by combining high-dimensional feature extraction, nonlinear priority estimation, and autonomous scheduling by AI, unlike human heuristics or simple time-series processing. This enables full automation and optimization of the entire analysis process, strongly supporting organizational decision-making and service quality improvement.

The analysis unit can adjust the order of analysis based on the relevance of the communication data during analysis. For example, the analysis unit preferentially analyzes highly relevant communication data. The analysis unit can postpone analysis of less relevant communication data. The analysis unit can adjust the order of analysis in stages according to relevance. Thus, by adjusting the order of analysis based on the relevance of the communication data, the analysis unit enables efficient analysis. Some or all of the above-described processing in the analysis unit may be performed using generative AI, or may be performed without using generative AI. For example, the analysis unit may input communication data into generative AI, and the generative AI may analyze the relevance of the data and adjust the order. Specifically, the analysis unit manages communication data received from the collection unit (e.g., email body, chat utterance, call record) and relevance evaluation targets (e.g., project information, past complaint history, business category) as structured data (body text+relevance attribute vector). The analysis unit uses natural language processing models (e.g., Transformer-based large language models) and semantic relevance estimation algorithms (e.g., cosine similarity, embedding vector distance, Attention weighting) to calculate relevance scores (continuous value from 0.0 to 1.0) between each communication data and evaluation target. Examples of AI input include “Body: ‘Proposal for a new NLP model,’ Related keyword: natural language processing” and “Body: ‘Product defect report,’ Related category: quality control.” Examples of AI output include “Relevance score: 0.92, Analysis order: 1” and “Relevance score: 0.35, Analysis order: 10.” The analysis unit controls the analysis job scheduler based on relevance scores, preferentially analyzing highly relevant data to improve work efficiency and report quality. In subsequent processing, prioritized analysis results are used for verbalization, dashboard display, automatic action plan generation, and other purposes. As a technical effect, the analysis unit can automatically adjust the order of analysis based on the relevance of the communication data, enabling rapid extraction of important information, postponement of noise data, and improved analysis efficiency compared to conventional uniform analysis methods or manual assignment. Furthermore, by optimizing AI model parameters and relevance evaluation algorithms, flexible adaptation to operational requirements for each industry and organization is possible, and rapid adaptation is possible when deployed to other companies. Application fields include extraction of related information in project management systems, anomaly detection in quality control departments, customer response history analysis in sales activities, and adaptive analysis for learning progress in educational settings, making it deployable to various relevance-adaptive analysis systems. The present invention realizes improvement of computer technology itself by combining high-dimensional feature extraction, semantic relevance estimation, and autonomous order control by AI, unlike manual data selection or simple keyword matching by humans. This enables full automation and optimization of the entire analysis process, strongly promoting organizational work efficiency and decision-making support.

The verbalization unit can estimate a user's emotion and adjust the method of verbalization based on the estimated emotion of the user. For example, when the user is feeling stressed, the verbalization unit performs simple and easy-to-understand verbalization. When the user is relaxed, the verbalization unit can provide detailed verbalization. When the user is in a hurry, the verbalization unit can perform verbalization that focuses on key points. By adjusting the method of verbalization according to the user's emotion, the verbalization unit can provide verbalization results that are easy for the user to understand. Emotion estimation is realized, for example, by using an emotion estimation function with an emotion engine or generative AI. Generative AI may include, for example, text generation AI (such as LLM) or multimodal generative AI, but is not limited to these examples. Some or all of the above-described processing in the verbalization unit may be performed using generative AI or without using generative AI. For example, the verbalization unit may input the user's emotion data to generative AI, and the generative AI can analyze the emotion data and adjust the method of verbalization. Specifically, the verbalization unit uses communication data (e.g., email body, chat utterances, speech recognition text, etc.) and biometric information (e.g., keystroke intervals, mouse operation speed, heart rate, skin conductance response, etc.) as multidimensional vectors (e.g., text 512 tokens+biometric sensor values 10 dimensions) as input data for emotion estimation. The verbalization unit inputs these data into Transformer-based large language models or multimodal neural networks, and outputs emotion classification (e.g., labels such as stress, relaxation, tension, impatience), emotion intensity scores (continuous values from 0.0 to 1.0), and time-series patterns of emotion changes. Examples of input include “Email body: ‘I am anxious because the delivery is delayed’, heart rate: 95 bpm, skin conductance response: high” or “Chat utterance: ‘I have plenty of time today’, keystroke interval: long”. Examples of AI output include “Emotion label: stress, intensity: 0.85” or “Emotion label: relaxation, intensity: 0.3”. Based on these outputs, the verbalization method adjustment module automatically adjusts according to rule-based or reinforcement learning algorithms, such as “If stress intensity is 0.7 or higher, increase the summarization rate and output in bullet points or short sentences”, “If relaxation intensity is 0.5 or higher, add detailed explanations and charts”, or “If in a hurry, extract only key points and output in shortened expressions”. For example, for users in a stressed state, a short summary such as “Main issue: delivery delay. Improvement proposal: strengthen delivery management.” is output, while for users in a relaxed state, a detailed explanation such as “The background of the delivery delay is a deficiency in process management, and there is a high risk of recurrence based on trends over the past three months. As improvement measures, reviewing the process and introducing progress management tools are effective.” is output. As subsequent processing, the adjusted verbalization results are used for dashboard display, reporting materials for management, and linkage to automatic action plan generation systems. As a technical effect, the verbalization unit can greatly improve user satisfaction and comprehension compared to conventional uniform output methods by automatically optimizing the expression method of verbalization results according to the user's psychological state. Furthermore, by optimizing AI model parameters and templates, customization according to specific industries and organizational structures is easy, and rapid adaptation is possible when deploying to other companies. Application fields include operator support in call centers, generation of explanatory materials for patients in medical settings, feedback on work status for remote workers, and generation of analysis reports for students in educational settings, and can be deployed to various user state-adaptive verbalization systems. The present invention, unlike human subjective judgment or simple template output, realizes improvement of computer technology itself by combining multivariate analysis, nonlinear pattern recognition, and autonomous expression optimization by AI. This enables automation and optimization of the entire verbalization process, strongly supporting organizational decision-making and service quality improvement.

The verbalization unit can adjust the level of detail of verbalization based on the importance of the extracted issues during verbalization. For example, the verbalization unit provides detailed verbalization for highly important issues. For less important issues, the verbalization unit can perform simplified verbalization. The verbalization unit can adjust the level of detail of verbalization stepwise according to the importance. By adjusting the level of detail of verbalization based on the importance of the extracted issues, the verbalization unit enables efficient verbalization. Some or all of the above-described processing in the verbalization unit may be performed using generative AI or without using generative AI. For example, the verbalization unit may input the extracted issues to generative AI, and the generative AI can analyze the importance of the issues and adjust the level of detail. Specifically, the verbalization unit utilizes lists of issues received from the analysis unit, summary texts, and structured data with importance scores (e.g., category, representative sentence, continuous value of importance from 0.0 to 1.0) as input, and applies encoder-decoder type generative models or large language models. For issues with high importance scores (e.g., 0.8 or higher), the verbalization unit automatically generates reports by combining multiple expression formats, such as detailed background explanations, impact analysis, concretization of improvement proposals, and chart generation. For example, for “Category: product defect, importance: 0.9, representative sentence: product does not work”, the output is a detailed description such as “The product defect has a significant impact on customer satisfaction, and 10 similar complaints have occurred in the past month. As improvement measures, it is necessary to review the quality management process and strengthen the support system.” For issues with low importance scores (e.g., 0.3 or lower), the output is a simplified expression such as “Category: general communication, summary: no special notes”. The verbalization unit controls branching of the verbalization pipeline according to the importance score, realizing optimal allocation of computational resources and homogenization of report quality. Examples of AI input include “Category: delivery delay, importance: 0.85, representative sentence: notification of delivery delay” or “Category: small talk, importance: 0.2, representative sentence: the weather is nice today”. Examples of AI output include “The background of the delivery delay is an issue in process management, and introduction of progress management tools is recommended as an improvement measure.” or “No special notes”. As subsequent processing, the verbalization results with adjusted level of detail are used for dashboard display, reporting materials for management, and linkage to automatic action plan generation systems. As a technical effect, the verbalization unit can realize efficient use of computational resources, faster report creation, prevention of missing important information, and homogenization of expression quality compared to conventional uniform output methods by automatically adjusting the level of detail of verbalization according to the importance of issues. Furthermore, by optimizing AI model parameters and branching algorithms, flexible adaptation to operational requirements of industries and organizations is possible, and rapid adaptation is possible when deploying to other companies. Application fields include call center complaint analysis reports, abnormality reports in quality management departments, case summaries in medical settings, and risk information organization in financial institutions, and can be deployed to various business domains where optimization of verbalization according to importance is required. The present invention, unlike human subjective judgment or simple uniform processing, realizes improvement of computer technology itself by combining high-dimensional feature extraction, nonlinear pattern recognition, and autonomous branching control by AI. This enables automation and optimization of the entire verbalization process, strongly supporting organizational decision-making and service quality improvement.

The verbalization unit can apply different verbalization algorithms according to the category of the extracted issues during verbalization. For example, the verbalization unit applies a specific verbalization algorithm for complaints from customers. For feedback from employees, the verbalization unit can apply a different verbalization algorithm. The verbalization unit can select and apply the optimal verbalization algorithm according to the category of the extracted issues. By applying different verbalization algorithms according to the category of the extracted issues, the verbalization unit can provide optimal verbalization results. Some or all of the above-described processing in the verbalization unit may be performed using generative AI or without using generative AI. For example, the verbalization unit may input the extracted issues to generative AI, and the generative AI can analyze the category of the issues and apply the optimal algorithm. Specifically, the verbalization unit receives lists of issues, summary texts, and structured data with category labels (e.g., category: complaint, feedback, general communication, etc.+representative sentence+importance, etc.) from the analysis unit as input, and includes a control module that automatically selects different verbalization algorithms for each category. For the complaint category, the verbalization unit combines encoder-decoder type generative models, emotion analysis modules, and causal explanation algorithms (e.g., attention weighting+causal graph generation) to generate detailed explanatory texts or tabular data including multidimensional elements such as “cause”, “impact”, and “improvement proposal”. For the feedback category, the verbalization unit applies summary generation algorithms (e.g., extractive summarization, generative summarization) and proposal content scoring modules to output summary texts or action plan lists emphasizing “proposal content”, “feasibility”, and “expected effect”. Examples of AI input include “Category: complaint, representative sentence: product does not work” or “Category: feedback, representative sentence: please consider introducing a new tool”. Examples of AI output include “Complaint details: product defect affects customer satisfaction. Improvement measure: strengthen quality management” or “Proposal content: tool introduction, feasibility: high, expected effect: 20% improvement in business efficiency”. By branching the verbalization pipeline for each category, the verbalization unit realizes optimal allocation of computational resources and improvement of expression quality. As subsequent processing, category-specific verbalization results are used for dashboard display, reporting materials for management, and linkage to automatic action plan generation systems. As a technical effect, the verbalization unit can greatly improve expression accuracy, speed, and flexibility compared to conventional uniform output methods by automatically applying the optimal verbalization algorithm according to the category of issues. Furthermore, by optimizing AI model parameters and algorithm selection rules, flexible adaptation to operational requirements of industries and organizations is possible, and rapid adaptation is possible when deploying to other companies. Application fields include call center complaint analysis reports, internal help desk feedback aggregation, abnormality reports in quality management departments, and case summaries in medical settings, and can be deployed to various business domains where category-adaptive verbalization is required. The present invention, unlike human heuristics or simple uniform processing, realizes improvement of computer technology itself by combining high-dimensional feature extraction, nonlinear pattern recognition, and autonomous algorithm selection by AI. This enables automation and optimization of the entire verbalization process, strongly supporting organizational decision-making and service quality improvement.

The verbalization unit can estimate a user's emotion and determine the priority of verbalization based on the estimated emotion of the user. For example, when the user is feeling stressed, the verbalization unit prioritizes verbalization of highly important issues. When the user is relaxed, the verbalization unit can prioritize verbalization of detailed issues. When the user is in a hurry, the verbalization unit can prioritize verbalization of issues that can be verbalized quickly. By determining the priority of verbalization according to the user's emotion, the verbalization unit can prioritize verbalization of important issues. Emotion estimation is realized, for example, by using an emotion estimation function with an emotion engine or generative AI. Generative AI may include, for example, text generation AI (such as LLM) or multimodal generative AI, but is not limited to these examples. Some or all of the above-described processing in the verbalization unit may be performed using generative AI or without using generative AI. For example, the verbalization unit may input the user's emotion data to generative AI, and the generative AI can analyze the emotion data and determine the priority of verbalization. Specifically, the verbalization unit uses communication data (e.g., email body, chat utterances, speech recognition text, etc.) and biometric information (e.g., keystroke intervals, mouse operation speed, heart rate, skin conductance response, etc.) as multidimensional vectors (e.g., text 512 tokens+biometric sensor values 10 dimensions) as input data for emotion estimation. The verbalization unit inputs these data into Transformer-based large language models or multimodal neural networks, and outputs emotion classification (e.g., labels such as stress, relaxation, tension, impatience), emotion intensity scores (continuous values from 0.0 to 1.0), and time-series patterns of emotion changes. Examples of input include “Email body: ‘I am anxious because the delivery is delayed’, heart rate: 95 bpm, skin conductance response: high” or “Chat utterance: ‘I have plenty of time today’, keystroke interval: long”. Examples of AI output include “Emotion label: stress, intensity: 0.85” or “Emotion label: relaxation, intensity: 0.3”. Based on these outputs, the priority determination module automatically adjusts according to rule-based or reinforcement learning algorithms, such as “If stress intensity is 0.7 or higher, prioritize issues with importance score 0.8 or higher”, “If relaxation intensity is 0.5 or higher, prioritize issues with detail score 0.5 or higher”, or “If in a hurry, prioritize issues with short verbalization time”. As subsequent processing, the determined priority is reflected in the verbalization job scheduler and used for dashboard display, reporting materials for management, and linkage to automatic action plan generation systems. As a technical effect, the verbalization unit can efficiently verbalize important issues without impairing the user experience by estimating the user's psychological state in real time and controlling priority automatically using high-dimensional feature extraction and automatic priority control by AI, compared to conventional fixed verbalization order methods. This enables both comprehensiveness in report creation and user satisfaction, contributing to business improvement and quality enhancement in customer response. Application fields include operator workload management in call centers, generation of explanatory materials for patients in medical settings, feedback on work status for remote workers, and generation of analysis reports for students in educational settings, and can be deployed to various user state-adaptive verbalization systems. The present invention, unlike human subjective judgment or simple prioritization, realizes improvement of computer technology itself by combining multivariate analysis, nonlinear pattern recognition, and autonomous control by AI. This enables automation and optimization of the entire verbalization process, strongly supporting organizational decision-making and service quality improvement.

The verbalization unit can adjust the order of verbalization based on the submission timing of the extracted issues during verbalization. For example, the verbalization unit prioritizes verbalization of the latest issues. Issues with older submission timing can be verbalized later. The verbalization unit can adjust the order of verbalization stepwise according to the submission timing. By adjusting the order of verbalization based on the submission timing of the extracted issues, the verbalization unit enables efficient verbalization. Some or all of the above-described processing in the verbalization unit may be performed using generative AI or without using generative AI. For example, the verbalization unit may input the extracted issues to generative AI, and the generative AI can analyze the submission timing of the issues and adjust the order. Specifically, the verbalization unit receives lists of issues, summary texts, and structured data with submission time (e.g., category, representative sentence, submission time in ISO8601 format) from the analysis unit as input, and the priority determination module automatically adjusts the verbalization order. The priority determination module applies rule-based control, such as prioritizing the latest issues (e.g., within one hour of submission) and postponing older issues (e.g., more than one day ago), or applies dynamic priority scoring using time-series analysis models (e.g., LSTM, autoregressive models). Examples of AI input include “Category: complaint, representative sentence: urgent response required, submission time: 2024-06-01T10: 00:00” or “Category: general communication, representative sentence: regular report, submission time: 2024-05-28T09: 00:00”. Examples of AI output include “Priority: high, verbalization order: 1” or “Priority: low, verbalization order: 10”. Based on the priority, the verbalization unit controls the verbalization job scheduler, realizing optimal allocation of computational resources and ensuring real-time performance. As subsequent processing, the prioritized verbalization results are used for dashboard display, reporting materials for management, and linkage to automatic action plan generation systems. As a technical effect, the verbalization unit can realize rapid processing of urgent information, prevention of business delays, and improvement of verbalization efficiency compared to conventional FIFO methods or manual assignment by automatically determining the verbalization order based on the submission timing of issues. Furthermore, by optimizing AI model parameters and priority determination algorithms, flexible adaptation to operational requirements of industries and organizations is possible, and rapid adaptation is possible when deploying to other companies. Application fields include emergency complaint handling in call centers, emergency case summarization in medical settings, and prioritization of risk information in financial institutions, and can be deployed to various business domains where time-series priority control is required. The present invention, unlike human heuristics or simple time-series processing, realizes improvement of computer technology itself by combining high-dimensional feature extraction, nonlinear priority estimation, and autonomous scheduling by AI. This enables automation and optimization of the entire verbalization process, strongly supporting organizational decision-making and service quality improvement.

The verbalization unit can adjust the order of verbalization based on the relevance of the extracted issues during verbalization. For example, the verbalization unit prioritizes verbalization of highly relevant issues. Issues with low relevance can be verbalized later. The verbalization unit can adjust the order of verbalization stepwise according to relevance. By adjusting the order of verbalization based on the relevance of the extracted issues, the verbalization unit enables efficient verbalization. Some or all of the above-described processing in the verbalization unit may be performed using generative AI or without using generative AI. For example, the verbalization unit may input the extracted issues to generative AI, and the generative AI can analyze the relevance of the issues and adjust the order. Specifically, the verbalization unit receives lists of issues, summary texts, and structured data with relevance attributes (e.g., category, representative sentence, related keywords, relevance score from 0.0 to 1.0) from the analysis unit as input, and uses natural language processing models (e.g., Transformer-based large language models) and semantic relevance estimation algorithms (e.g., cosine similarity, embedding vector distance, attention weighting) to calculate relevance scores between each issue and evaluation targets (e.g., project information, past complaint history, business category, etc.). Examples of AI input include “Category: technical consultation, representative sentence: proposal for new NLP model, related keywords: natural language processing” or “Category: quality management, representative sentence: product defect report, related category: quality management”. Examples of AI output include “Relevance score: 0.92, verbalization order: 1” or “Relevance score: 0.35, verbalization order: 10”. Based on the relevance score, the verbalization unit controls the verbalization job scheduler and prioritizes verbalization of highly relevant issues, thereby improving business efficiency and report quality. As subsequent processing, the prioritized verbalization results are used for dashboard display, reporting materials for management, and linkage to automatic action plan generation systems. As a technical effect, the verbalization unit can realize rapid extraction of important information, postponement of noise data, and improvement of verbalization efficiency compared to conventional uniform output methods or manual assignment by automatically adjusting the verbalization order based on relevance. Furthermore, by optimizing AI model parameters and relevance evaluation algorithms, flexible adaptation to operational requirements of industries and organizations is possible, and rapid adaptation is possible when deploying to other companies. Application fields include organization of related information in project management systems, abnormality reports in quality management departments, customer response history summarization in sales activities, and generation of adaptive progress reports for students in educational settings, and can be deployed to various relevance-adaptive verbalization systems. The present invention, unlike manual data selection or simple keyword matching by humans, realizes improvement of computer technology itself by combining high-dimensional feature extraction, semantic relevance estimation, and autonomous order control by AI. This enables automation and optimization of the entire verbalization process, strongly promoting organizational business efficiency and decision-making support.

The system according to the embodiment is not limited to the above examples and can be variously modified as follows. Specifically, the system can flexibly change the module configuration of the collection unit, analysis unit, and verbalization unit, data flow, AI model architecture, input/output data formats, and control algorithms according to various business requirements and operational environments. For example, the collection unit can support various data sources in addition to emails, chats, and call center histories, such as IoT sensor data, business daily reports, SNS posts, image and audio data, and can be implemented by combining multiple data acquisition methods such as API integration, stream processing, and batch processing. The analysis unit can realize various analysis functions such as natural language processing, emotion analysis, anomaly detection, topic classification, summarization, and causal relationship extraction by linking multiple AI models in parallel or sequentially, such as Transformer-based large language models, BERT, LSTM, graph neural networks, and time-series analysis models. The verbalization unit can support various output formats such as text, tables, graphs, and audio by combining encoder-decoder type generative models, template engines, chart generation modules, and speech synthesis engines. Examples of AI input include “IoT sensor value: temperature 25.3° C., humidity 60%, anomaly flag: ON”, “SNS post: ‘The new product has a good reputation’”, “Image data: JPEG format, resolution 1024×768”, and examples of AI output include “Anomaly detection result: temperature anomaly, recommended action: check cooling device”, “SNS trend: positive, topic score: 0.8”, “Image classification: product appearance anomaly, confidence: 0.92”. As subsequent processing, these outputs can be linked to various business systems such as dashboard display, automatic action plan generation, KPI management systems, on-site work instructions, and voice notifications. As a technical effect, the system can greatly improve scalability, maintainability, and reusability by flexibly changing module configuration, AI models, and data flow, making optimization easy according to differences in industry, organization size, and operational environment. Application fields include quality management in manufacturing, anomaly monitoring in logistics sites, case analysis in medical institutions, learning progress management in educational settings, and crisis management in public institutions, and can be deployed to a wide range of business domains. The present invention, by combining high-dimensional feature extraction, multiple model linkage, dynamic control, and support for various data formats by AI, realizes improvement of computer technology itself, not limited to simple business automation. This enables automation, optimization, and improved scalability of the entire system, strongly promoting operational efficiency and decision-making support for organizations.

The analysis unit can estimate a user's emotion and determine the priority of analysis based on the estimated emotion of the user. For example, when the user is feeling stressed, the analysis unit prioritizes analysis of highly important issues. When the user is relaxed, the analysis unit can perform detailed analysis. When the user is in a hurry, the analysis unit can prioritize analysis of issues that can be analyzed quickly. By determining the priority of analysis according to the user's emotion, the analysis unit can prioritize analysis of important issues. Emotion estimation is realized, for example, by using an emotion estimation function with an emotion engine or generative AI. Generative AI may include, for example, text generation AI (such as LLM) or multimodal generative AI, but is not limited to these examples. Some or all of the above-described processing in the analysis unit may be performed using generative AI or without using generative AI. For example, the analysis unit may input the user's emotion data to generative AI, and the generative AI can analyze the emotion data and determine the priority. Specifically, the analysis unit uses communication data (e.g., email body, chat utterances, speech recognition text, etc.) and biometric information (e.g., keystroke intervals, mouse operation speed, heart rate, skin conductance response, etc.) as multidimensional vectors (e.g., text 512 tokens+biometric sensor values 10 dimensions) as input data for emotion estimation. The analysis unit inputs these data into Transformer-based large language models or multimodal neural networks, and outputs emotion classification (e.g., labels such as stress, relaxation, tension, impatience), emotion intensity scores (continuous values from 0.0 to 1.0), and time-series patterns of emotion changes. Examples of input include “Email body: ‘I am anxious because the delivery is delayed’, heart rate: 95 bpm, skin conductance response: high” or “Chat utterance: ‘I have plenty of time today’, keystroke interval: long”. Examples of AI output include “Emotion label: stress, intensity: 0.85” or “Emotion label: relaxation, intensity: 0.3”. Based on these outputs, the priority determination module automatically adjusts according to rule-based or reinforcement learning algorithms, such as “If stress intensity is 0.7 or higher, prioritize issues with importance score 0.8 or higher”, “If relaxation intensity is 0.5 or higher, prioritize issues with detail score 0.5 or higher”, or “If in a hurry, prioritize issues with short analysis time”. As subsequent processing, the determined priority is reflected in the analysis job scheduler and used for dashboard display, reporting materials for management, and linkage to automatic action plan generation systems. As a technical effect, the analysis unit can efficiently analyze important issues without impairing the user experience by estimating the user's psychological state in real time and controlling priority automatically using high-dimensional feature extraction and automatic priority control by AI, compared to conventional fixed analysis order methods. This enables both comprehensiveness in report creation and user satisfaction, contributing to business improvement and quality enhancement in customer response. Application fields include operator workload management in call centers, generation of explanatory materials for patients in medical settings, feedback on work status for remote workers, and generation of analysis reports for students in educational settings, and can be deployed to various user state-adaptive analysis systems. The present invention, unlike human subjective judgment or simple prioritization, realizes improvement of computer technology itself by combining multivariate analysis, nonlinear pattern recognition, and autonomous control by AI. This enables automation and optimization of the entire analysis process, strongly supporting organizational decision-making and service quality improvement.

The collection unit can estimate a user's emotion and determine the type of communication data to be collected based on the estimated emotion of the user. For example, when the user is feeling stressed, the collection unit prioritizes collection of highly important communication data. When the user is relaxed, the collection unit can prioritize collection of detailed communication data. When the user is in a hurry, the collection unit can prioritize collection of communication data that can be collected quickly. By determining the type of communication data to be collected according to the user's emotion, the collection unit can prioritize collection of important data. Emotion estimation is realized, for example, by using an emotion estimation function with an emotion engine or generative AI. Generative AI may include, for example, text generation AI (such as LLM) or multimodal generative AI, but is not limited to these examples. Some or all of the above-described processing in the collection unit may be performed using generative AI or without using generative AI. For example, the collection unit may input the user's emotion data to generative AI, and the generative AI can analyze the emotion data and determine the type of communication data to be collected. Specifically, the collection unit uses communication data (e.g., email body, chat utterances, speech recognition text, etc.) and biometric information (e.g., keystroke intervals, mouse operation speed, heart rate, skin conductance response, etc.) as multidimensional vectors (e.g., text 512 tokens+biometric sensor values 10 dimensions) as input data for emotion estimation. The collection unit inputs these data into Transformer-based large language models or multimodal neural networks, and outputs emotion classification (e.g., labels such as stress, relaxation, tension, impatience), emotion intensity scores (continuous values from 0.0 to 1.0), and time-series patterns of emotion changes. Examples of input include “Email body: ‘I am anxious because the delivery is delayed’, heart rate: 95 bpm, skin conductance response: high” or “Chat utterance: ‘I have plenty of time today’, keystroke interval: long”. Examples of AI output include “Emotion label: stress, intensity: 0.85” or “Emotion label: relaxation, intensity: 0.3”. Based on these outputs, the data type determination module automatically adjusts according to rule-based or reinforcement learning algorithms, such as “If stress intensity is 0.7 or higher, prioritize communication data with importance score 0.8 or higher”, “If relaxation intensity is 0.5 or higher, prioritize communication data with detail score 0.5 or higher”, or “If in a hurry, prioritize communication data with short collection time”. As subsequent processing, the determined data type is reflected in the collection job scheduler and used for recording in the database and notification to administrators. As a technical effect, the collection unit can efficiently collect important data without impairing the user experience by estimating the user's psychological state in real time and controlling data type automatically using high-dimensional feature extraction and automatic data type control by AI, compared to conventional fixed collection methods. This enables both comprehensiveness in data collection and user satisfaction, contributing to business improvement and quality enhancement in customer response. Application fields include operator workload management in call centers, patient stress monitoring in medical settings, work status monitoring for remote workers, and estimation of student concentration in educational settings, and can be deployed to various user state-adaptive data collection systems. The present invention, unlike human subjective judgment or simple data type selection, realizes improvement of computer technology itself by combining multivariate analysis, nonlinear pattern recognition, and autonomous control by AI. This enables automation and optimization of the entire data collection process, strongly supporting organizational decision-making and service quality improvement.

The verbalization unit can estimate a user's emotion and adjust the expression method of verbalization based on the estimated emotion of the user. For example, when the user is feeling stressed, the verbalization unit performs simple and easy-to-understand verbalization. When the user is relaxed, the verbalization unit can provide detailed verbalization. When the user is in a hurry, the verbalization unit can perform verbalization that focuses on key points. By adjusting the expression method of verbalization according to the user's emotion, the verbalization unit can provide verbalization results that are easy for the user to understand. Emotion estimation is realized, for example, by using an emotion estimation function with an emotion engine or generative AI. Generative AI may include, for example, text generation AI (such as LLM) or multimodal generative AI, but is not limited to these examples. Some or all of the above-described processing in the verbalization unit may be performed using generative AI or without using generative AI. For example, the verbalization unit may input the user's emotion data to generative AI, and the generative AI can analyze the emotion data and adjust the expression method. Specifically, the verbalization unit uses communication data (e.g., email body, chat utterances, speech recognition text, etc.) and biometric information (e.g., keystroke intervals, mouse operation speed, heart rate, skin conductance response, etc.) as multidimensional vectors (e.g., text 512 tokens+biometric sensor values 10 dimensions) as input data for emotion estimation. The verbalization unit inputs these data into Transformer-based large language models or multimodal neural networks, and outputs emotion classification (e.g., labels such as stress, relaxation, tension, impatience), emotion intensity scores (continuous values from 0.0 to 1.0), and time-series patterns of emotion changes. Examples of input include “Email body: ‘I am anxious because the delivery is delayed’, heart rate: 95 bpm, skin conductance response: high” or “Chat utterance: ‘I have plenty of time today’, keystroke interval: long”. Examples of AI output include “Emotion label: stress, intensity: 0.85” or “Emotion label: relaxation, intensity: 0.3”. Based on these outputs, the expression method adjustment module automatically adjusts according to rule-based or reinforcement learning algorithms, such as “If stress intensity is 0.7 or higher, increase the summarization rate and output in bullet points or short sentences”, “If relaxation intensity is 0.5 or higher, add detailed explanations and charts”, or “If in a hurry, extract only key points and output in shortened expressions”. For example, for users in a stressed state, a short summary such as “Main issue: delivery delay. Improvement proposal: strengthen delivery management.” is output, while for users in a relaxed state, a detailed explanation such as “The background of the delivery delay is a deficiency in process management, and there is a high risk of recurrence based on trends over the past three months. As improvement measures, reviewing the process and introducing progress management tools are effective.” is output. As subsequent processing, the adjusted verbalization results are used for dashboard display, reporting materials for management, and linkage to automatic action plan generation systems. As a technical effect, the verbalization unit can greatly improve user satisfaction and comprehension compared to conventional uniform output methods by automatically optimizing the expression method of verbalization results according to the user's psychological state. Furthermore, by optimizing AI model parameters and templates, customization according to specific industries and organizational structures is easy, and rapid adaptation is possible when deploying to other companies. Application fields include operator support in call centers, generation of explanatory materials for patients in medical settings, feedback on work status for remote workers, and generation of analysis reports for students in educational settings, and can be deployed to various user state-adaptive verbalization systems. The present invention, unlike human subjective judgment or simple template output, realizes improvement of computer technology itself by combining multivariate analysis, nonlinear pattern recognition, and autonomous expression optimization by AI. This enables automation and optimization of the entire verbalization process, strongly supporting organizational decision-making and service quality improvement.

The analysis unit can estimate a user's emotion and adjust the level of detail of analysis based on the estimated emotion of the user. For example, when the user is feeling stressed, the analysis unit provides concise analysis results focusing on key points. When the user is relaxed, the analysis unit can provide detailed analysis results. When the user is in a hurry, the analysis unit can summarize the analysis results concisely for quick understanding. By adjusting the level of detail of analysis according to the user's emotion, the analysis unit can provide analysis results that are easy for the user to understand. Emotion estimation is realized, for example, by using an emotion estimation function with an emotion engine or generative AI. Generative AI may include, for example, text generation AI (such as LLM) or multimodal generative AI, but is not limited to these examples. Some or all of the above-described processing in the analysis unit may be performed using generative AI or without using generative AI. For example, the analysis unit may input the user's emotion data to generative AI, and the generative AI can analyze the emotion data and adjust the level of detail. Specifically, the analysis unit uses communication data (e.g., email body, chat utterances, speech recognition text, etc.) and biometric information (e.g., keystroke intervals, mouse operation speed, heart rate, skin conductance response, etc.) as multidimensional vectors (e.g., text 512 tokens+biometric sensor values 10 dimensions) as input data for emotion estimation. The analysis unit inputs these data into Transformer-based large language models or multimodal neural networks, and outputs emotion classification (e.g., labels such as stress, relaxation, tension, impatience), emotion intensity scores (continuous values from 0.0 to 1.0), and time-series patterns of emotion changes. Examples of input include “Email body: ‘I am anxious because the delivery is delayed’, heart rate: 95 bpm, skin conductance response: high” or “Chat utterance: ‘I have plenty of time today’, keystroke interval: long”. Examples of AI output include “Emotion label: stress, intensity: 0.85” or “Emotion label: relaxation, intensity: 0.3”. Based on these outputs, the detail adjustment module automatically adjusts according to rule-based or reinforcement learning algorithms, such as “If stress intensity is 0.7 or higher, increase the summarization rate and output in bullet points or short sentences”, “If relaxation intensity is 0.5 or higher, add detailed explanations and charts”, or “If in a hurry, extract only key points and output in shortened expressions”. For example, for users in a stressed state, a short summary such as “Main issue: delivery delay. Improvement proposal: strengthen delivery management.” is output, while for users in a relaxed state, a detailed explanation such as “The background of the delivery delay is a deficiency in process management, and there is a high risk of recurrence based on trends over the past three months. As improvement measures, reviewing the process and introducing progress management tools are effective.” is output. As subsequent processing, the adjusted analysis results are used by the verbalization unit, for dashboard display, automatic action plan generation, and other uses. As a technical effect, the analysis unit can greatly improve user satisfaction and comprehension compared to conventional uniform output methods by automatically optimizing the level of detail of analysis results according to the user's psychological state. Furthermore, by optimizing AI model parameters and templates, customization according to specific industries and organizational structures is easy, and rapid adaptation is possible when deploying to other companies. Application fields include operator support in call centers, generation of explanatory materials for patients in medical settings, feedback on work status for remote workers, and generation of analysis reports for students in educational settings, and can be deployed to various user state-adaptive analysis systems. The present invention, unlike human subjective judgment or simple template output, realizes improvement of computer technology itself by combining multivariate analysis, nonlinear pattern recognition, and autonomous expression optimization by AI. This enables automation and optimization of the entire analysis process, strongly supporting organizational decision-making and service quality improvement.

The collection unit can estimate a user's emotion and perform filtering of communication data to be collected based on the estimated emotion of the user. For example, when the user is feeling stressed, the collection unit prioritizes collection of highly important communication data. When the user is relaxed, the collection unit can prioritize collection of detailed communication data. When the user is in a hurry, the collection unit can prioritize collection of communication data that can be collected quickly. By performing filtering of communication data to be collected according to the user's emotion, the collection unit can prioritize collection of important data. Emotion estimation is realized, for example, by using an emotion estimation function with an emotion engine or generative AI. Generative AI may include, for example, text generation AI (such as LLM) or multimodal generative AI, but is not limited to these examples. Some or all of the above-described processing in the collection unit may be performed using generative AI or without using generative AI. For example, the collection unit may input the user's emotion data to generative AI, and the generative AI can analyze the emotion data and perform filtering. Specifically, the collection unit uses communication data (e.g., email body, chat utterances, speech recognition text, etc.) and biometric information (e.g., keystroke intervals, mouse operation speed, heart rate, skin conductance response, etc.) as multidimensional vectors (e.g., text 512 tokens+biometric sensor values 10 dimensions) as input data for emotion estimation. The collection unit inputs these data into Transformer-based large language models or multimodal neural networks, and outputs emotion classification (e.g., labels such as stress, relaxation, tension, impatience), emotion intensity scores (continuous values from 0.0 to 1.0), and time-series patterns of emotion changes. Examples of input include “Email body: ‘I am anxious because the delivery is delayed’, heart rate: 95 bpm, skin conductance response: high” or “Chat utterance: ‘I have plenty of time today’, keystroke interval: long”. Examples of AI output include “Emotion label: stress, intensity: 0.85” or “Emotion label: relaxation, intensity: 0.3”. Based on these outputs, the filtering module automatically adjusts according to rule-based or reinforcement learning algorithms, such as “If stress intensity is 0.7 or higher, prioritize communication data with importance score 0.8 or higher”, “If relaxation intensity is 0.5 or higher, prioritize communication data with detail score 0.5 or higher”, or “If in a hurry, prioritize communication data with short collection time”. As subsequent processing, the filtered data are linked to the analysis unit and verbalization unit, and used for dashboard display, reporting materials for management, and linkage to automatic action plan generation systems. As a technical effect, the collection unit can efficiently collect important data without impairing the user experience by estimating the user's psychological state in real time and controlling filtering automatically using high-dimensional feature extraction and automatic filtering control by AI, compared to conventional fixed collection methods. This enables both comprehensiveness in data collection and user satisfaction, contributing to business improvement and quality enhancement in customer response. Application fields include operator workload management in call centers, patient stress monitoring in medical settings, work status monitoring for remote workers, and estimation of student concentration in educational settings, and can be deployed to various user state-adaptive data collection systems. The present invention, unlike human subjective judgment or simple filtering, realizes improvement of computer technology itself by combining multivariate analysis, nonlinear pattern recognition, and autonomous control by AI. This enables automation and optimization of the entire data collection process, strongly supporting organizational decision-making and service quality improvement.

The analysis unit can determine the priority of analysis based on the importance of communication data. For example, the analysis unit prioritizes analysis of highly important communication data. Communication data with low importance can be analyzed later. The analysis unit can adjust the priority of analysis stepwise according to importance. By determining the priority of analysis based on the importance of communication data, the analysis unit enables efficient analysis. Some or all of the above-described processing in the analysis unit may be performed using generative AI or without using generative AI. For example, the analysis unit may input communication data to generative AI, and the generative AI can analyze the importance of the data and determine the priority. Specifically, the analysis unit manages communication data received from the collection unit (e.g., email body, chat utterances, call center call records, etc.) as structured data (e.g., sender, recipient, subject, body, timestamp, importance score, etc., as a 10-dimensional vector). For data with high importance scores (e.g., continuous values from 0.0 to 1.0), the analysis unit applies multiple stages of detailed analysis pipelines using natural language processing models such as Transformer-based large language models, BERT, and LSTM, including morphological analysis, grammatical analysis, semantic analysis, emotion analysis, topic classification, causal relationship extraction, and summarization. For example, for a complaint email with importance 0.9 (e.g., “Your product does not work. Support response is also slow.”), the output is structured data with multiple items such as “Category: product defect, cause: malfunction, impact: customer dissatisfaction, emotion: dissatisfaction, importance: 0.9, detailed summary: review of support system required”. For data with low importance (e.g., importance 0.2 for a routine communication email), only morphological analysis and simple topic classification are applied, and the output is a simplified result such as “Category: general communication, importance: 0.2, summary: no special notes”. The analysis unit controls branching of the analysis pipeline according to the importance score, realizing optimal allocation of computational resources and leveling of processing load. Examples of AI input include “Email body: ‘I am anxious because the delivery is delayed’, importance: 0.85” or “Chat utterance: ‘I have plenty of time today’, importance: 0.3”. Examples of AI output include “Category: delivery delay, emotion: anxiety, detailed summary: recommend review of delivery management process” or “Category: small talk, summary: no special notes”. As subsequent processing, detailed analysis results are linked to the verbalization unit and used for management reports, automatic action plan generation, and input to KPI management systems. As a technical effect, the analysis unit can realize efficient use of computational resources, improved processing speed, prevention of missing important information, and homogenization of report quality compared to conventional uniform analysis methods by automatically adjusting the priority of analysis according to the importance of communication data. Furthermore, by optimizing AI model parameters and branching algorithms, flexible adaptation to operational requirements of industries and organizations is possible, and rapid adaptation is possible when deploying to other companies. Application fields include complaint analysis in call centers, anomaly detection in quality management departments, urgency assessment in medical settings, and risk information extraction in financial institutions, and can be deployed to various business domains where optimization of analysis according to importance is required. The present invention, unlike human subjective judgment or simple uniform processing, realizes improvement of computer technology itself by combining high-dimensional feature extraction, nonlinear pattern recognition, and autonomous branching control by AI. This enables automation and optimization of the entire analysis process, strongly supporting organizational decision-making and service quality improvement.

The collection unit can analyze a user's past communication data collection history and select an optimal collection method. For example, the collection unit prioritizes selection of communication data collection methods that the user has frequently used in the past. The collection unit can select the most efficient collection method based on the user's past communication data collection history. The collection unit can analyze the user's past communication data collection history and select the optimal collection timing. By analyzing the user's past communication data collection history, the collection unit can select the optimal collection method and enable efficient data collection. Some or all of the above-described processing in the collection unit may be performed using generative AI or without using generative AI. For example, the collection unit may input the user's past communication data collection history to generative AI, and the generative AI can analyze the history and select the optimal collection method. Specifically, the collection unit manages each user's past communication data collection history (e.g., collection date and time, collection method type, collected data type, collection success rate, time required for collection, user response, etc.) as a time-series database. The collection unit inputs these history data as time-series arrays (e.g., each history record as a 20-dimensional vector, array of the past 100 records) into recurrent neural networks (e.g., LSTM, GRU) or time-series analysis models (e.g., autoregressive models, time-series clustering). Examples of AI input include “History: 2024-06-01 10:00 email automatic collection success, 2024-06-01 12:00 chat manual collection failure, 2024-06-02 09:00 call center automatic collection success”. Examples of AI output include “Recommended collection method: email automatic collection, recommended timing: morning, expected success rate: 0.95” or “Recommended collection method: chat automatic collection, recommended timing: after work”. Based on the AI output, the collection method selection module applies rules such as “Prioritize methods with high past success rates”, “Recommend automatic collection if the user dislikes manual collection”, or “Optimize for specific days of the week and times”, and automatically adjusts the collection schedule and method. As subsequent processing, the selected collection method and timing are reflected in the collection job scheduler and used for recording in the database and generating reports for administrators. As a technical effect, the collection unit can greatly improve data collection efficiency, success rate, and user satisfaction compared to conventional uniform collection methods by autonomously determining the optimal collection strategy through AI analysis of user behavior patterns and past collection performance. Application fields include optimization of call center call record collection, optimization of patient data collection timing in medical settings, efficient collection of IoT sensor data, and collection of work logs for remote workers, and can be deployed to various history-adaptive data collection systems. The present invention, unlike human heuristics or simple scheduling, realizes improvement of computer technology itself by combining high-dimensional history analysis, pattern extraction, and autonomous optimization by AI. This enables automation and optimization of the entire data collection process, strongly supporting operational efficiency and data quality improvement for organizations.

The analysis unit can apply different analysis algorithms according to the category of communication data. For example, the analysis unit applies a specific analysis algorithm for complaint data from customers. For feedback data from employees, the analysis unit can apply a different analysis algorithm. The analysis unit can select and apply the optimal analysis algorithm according to the category of communication data. By applying different analysis algorithms according to the category of communication data, the analysis unit can provide optimal analysis results. Some or all of the above-described processing in the analysis unit may be performed using generative AI or without using generative AI. For example, the analysis unit may input communication data to generative AI, and the generative AI can analyze the category of the data and apply the optimal algorithm. Specifically, the analysis unit manages communication data received from the collection unit (e.g., email body, chat utterances, call center call records, etc.) as structured data with category attributes (e.g., category label+body text+metadata, such as complaint, feedback, general communication, technical consultation, etc.). The analysis unit includes a control module that automatically selects different analysis algorithms for each category. For complaint data (category: complaint), the analysis unit combines Transformer-based large language models, emotion analysis modules, and causal relationship extraction algorithms (e.g., attention weighting+causal graph generation) to extract multidimensional features such as “cause”, “impact”, “emotion”, and “improvement proposal”. For employee feedback (category: feedback), the analysis unit applies time-series models such as LSTM or GRU and summary generation algorithms (e.g., extractive summarization, generative summarization) to extract features such as “proposal content”, “feasibility”, and “expected effect”. Examples of AI input include “Category: complaint, body: ‘Product does not work’” or “Category: feedback, body: ‘Please consider introducing a new tool’”. Examples of AI output include “Category: complaint, cause: malfunction, emotion: dissatisfaction, improvement proposal: strengthen support system” or “Category: feedback, proposal content: tool introduction, feasibility: high, expected effect: 20% improvement in business efficiency”. By branching the analysis pipeline for each category, the analysis unit realizes optimal allocation of computational resources and improvement of analysis accuracy. As subsequent processing, category-specific analysis results are linked to the verbalization unit, used for dashboard display, and automatic action plan generation. As a technical effect, the analysis unit can greatly improve analysis accuracy, speed, and flexibility compared to conventional uniform analysis methods by automatically applying the optimal analysis algorithm according to the category of communication data. Furthermore, by optimizing AI model parameters and algorithm selection rules, flexible adaptation to operational requirements of industries and organizations is possible, and rapid adaptation is possible when deploying to other companies. Application fields include complaint analysis in call centers, feedback aggregation in internal help desks, anomaly detection in quality management departments, and case classification in medical settings, and can be deployed to various business domains where category-adaptive analysis is required. The present invention, unlike human heuristics or simple uniform processing, realizes improvement of computer technology itself by combining high-dimensional feature extraction, nonlinear pattern recognition, and autonomous algorithm selection by AI. This enables automation and optimization of the entire analysis process, strongly supporting organizational decision-making and service quality improvement.

The collection unit can prioritize collection of highly relevant data based on the user's geographic location information when collecting communication data. For example, when the user is in a specific region, the collection unit prioritizes collection of communication data related to that region. The collection unit can filter and collect highly relevant communication data based on the user's geographic location information. When the user is moving, the collection unit can prioritize collection of communication data related to the current location. By prioritizing collection of highly relevant data based on the user's geographic location information, the collection unit enables efficient data collection. Some or all of the above-described processing in the collection unit may be performed using generative AI or without using generative AI. For example, the collection unit may input the user's geographic location information to generative AI, and the generative AI can analyze the information and prioritize collection of highly relevant data. Specifically, the collection unit obtains the user's geographic location information (e.g., GPS coordinates, Wi-Fi access point information, base station ID, etc.) as a 3-dimensional vector (latitude, longitude, altitude) or time-series array (movement history), and manages it in combination with metadata of communication data (e.g., sender/recipient region, place names in content, tags, etc.). The collection unit inputs these data into Transformer-based large language models or geospatial information processing modules, and outputs geographic relevance scores (continuous values from 0.0 to 1.0) and priority labels (high, medium, low). Examples of input include “Current location: Chiyoda-ku, Tokyo, communication data: ‘About the meeting at Tokyo branch’” or “Current location: Osaka City, communication data: ‘Customer response in Kansai area’”. Examples of AI output include “Relevance score: 0.95, priority: high” or “Relevance score: 0.40, priority: low”. Based on the AI output, the collection unit prioritizes collection of communication data with relevance above a threshold (e.g., 0.7), and dynamically extracts data related to the destination region when the user is moving. As subsequent processing, the prioritized collected data are linked to the analysis unit and verbalization unit, and used for generation of region-specific reports and local response plans. As a technical effect, the collection unit can greatly reduce data noise and redundancy and improve the accuracy and efficiency of analysis and report generation compared to conventional comprehensive collection methods by efficiently collecting only highly relevant data according to the user's current location and movement history. Application fields include region-specific customer response history management in sales activities, location-linked business support for field workers, local information collection during disasters, and delivery status monitoring in logistics sites, and can be deployed to various geographic information-adaptive data collection systems. The present invention, unlike manual data selection or simple place name matching by humans, realizes improvement of computer technology itself by combining high-dimensional feature extraction, semantic relevance estimation, and dynamic rule application by AI. This enables automation and optimization of the entire data collection process, strongly promoting organizational business efficiency and decision-making support.

The verbalization unit can adjust the level of detail of verbalization based on the importance of the extracted issues during verbalization. For example, the verbalization unit provides detailed verbalization for highly important issues. For less important issues, the verbalization unit can perform simplified verbalization. The verbalization unit can adjust the level of detail of verbalization stepwise according to the importance. By adjusting the level of detail of verbalization based on the importance of the extracted issues, the verbalization unit enables efficient verbalization. Some or all of the above-described processing in the verbalization unit may be performed using generative AI or without using generative AI. For example, the verbalization unit may input the extracted issues to generative AI, and the generative AI can analyze the importance of the issues and adjust the level of detail. Specifically, the verbalization unit utilizes lists of issues received from the analysis unit, summary texts, and structured data with importance scores (e.g., category, representative sentence, continuous value of importance from 0.0 to 1.0) as input, and applies encoder-decoder type generative models or large language models. For issues with high importance scores (e.g., 0.8 or higher), the verbalization unit automatically generates reports by combining multiple expression formats, such as detailed background explanations, impact analysis, concretization of improvement proposals, and chart generation. For example, for “Category: product defect, importance: 0.9, representative sentence: product does not work”, the output is a detailed description such as “The product defect has a significant impact on customer satisfaction, and 10 similar complaints have occurred in the past month. As improvement measures, it is necessary to review the quality management process and strengthen the support system.” For issues with low importance scores (e.g., 0.3 or lower), the output is a simplified expression such as “Category: general communication, summary: no special notes”. The verbalization unit controls branching of the verbalization pipeline according to the importance score, realizing optimal allocation of computational resources and homogenization of report quality. Examples of AI input include “Category: delivery delay, importance: 0.85, representative sentence: notification of delivery delay” or “Category: small talk, importance: 0.2, representative sentence: the weather is nice today”. Examples of AI output include “The background of the delivery delay is an issue in process management, and introduction of progress management tools is recommended as an improvement measure.” or “No special notes”. As subsequent processing, the verbalization results with adjusted level of detail are used for dashboard display, reporting materials for management, and linkage to automatic action plan generation systems. As a technical effect, the verbalization unit can realize efficient use of computational resources, faster report creation, prevention of missing important information, and homogenization of expression quality compared to conventional uniform output methods by automatically adjusting the level of detail of verbalization according to the importance of issues. Furthermore, by optimizing AI model parameters and branching algorithms, flexible adaptation to operational requirements of industries and organizations is possible, and rapid adaptation is possible when deploying to other companies. Application fields include call center complaint analysis reports, abnormality reports in quality management departments, case summaries in medical settings, and risk information organization in financial institutions, and can be deployed to various business domains where optimization of verbalization according to importance is required. The present invention, unlike human subjective judgment or simple uniform processing, realizes improvement of computer technology itself by combining high-dimensional feature extraction, nonlinear pattern recognition, and autonomous branching control by AI. This enables automation and optimization of the entire verbalization process, strongly supporting organizational decision-making and service quality improvement.

The following is a brief explanation of the processing flow of Example of the Embodiment. Specifically, the processing flow in Example of the present invention is configured as a multi-stage AI pipeline in which the collection unit, analysis unit, and verbalization unit modules operate in cooperation. First, the system automatically acquires communication data from multiple data sources such as mail servers, chat servers, and call center record databases via the collection unit. When acquiring data, the collection unit vectorizes the communication data and stores it as structured data (e.g., a 4-dimensional vector consisting of sender, recipient, subject, and body for emails). Chat histories and call center histories are similarly managed as multidimensional arrays including sender, recipient, utterance content, timestamp, etc. The collection unit also automatically performs preprocessing such as duplicate elimination and noise removal to ensure data quality. Next, the analysis unit receives the structured data from the collection unit as input and inputs it into a natural language processing model (e.g., Transformer-based large language model). Examples of input include email body text (length 512 tokens), chat utterance sequences (time-series arrays, each utterance 100 tokens), and call center call records (speech recognition result text, 1000 tokens). The analysis unit applies morphological analysis, grammatical analysis, and semantic analysis in stages to generate features such as key phrase extraction, emotion analysis, and topic classification. For example, the analysis unit classifies the causes of complaints into categories such as “product defect”, “delayed response”, and “insufficient explanation”, and calculates occurrence frequency and impact scores (continuous values from 0.0 to 1.0) for each category. The output of the analysis unit is a list of extracted issues (e.g., {‘category’: ‘product defect’, ‘frequency’: 0.35, ‘representative sentence’: ‘product does not work’}), structured data with importance scores, or summary texts for each issue. The verbalization unit receives the output from the analysis unit and inputs it into a report generation model (e.g., encoder-decoder type generative model). The verbalization unit automatically generates reports in multiple expression formats such as bullet points, tables, and narrative summaries based on the list of extracted issues and summary texts. For example, it outputs specific sentences such as “The main causes of customer complaints are product defects (35%), delayed response (20%), and insufficient explanation (15%). Improvement proposals include enhancement of FAQs and revision of response manuals.” The output format can support various formats such as PDF, HTML, and CSV. Examples of AI input and output include input such as “Customer complaint email body (e.g., ‘Your product does not work. I contacted support but the response was slow.’)” or “Employee feedback (e.g., ‘Please consider introducing a new tool’)”, and output such as “Issue category: delayed response, importance: 0.8” or “Improvement proposal: consider tool introduction” as structured data or summary text. As subsequent processing, these outputs are used for dashboard display for management, automatic action plan generation, and linkage to KPI management systems. As a technical effect, the system can greatly improve processing speed and reduce variation in extraction accuracy compared to manual reading of large volumes of communication data by humans, and can stably generate highly reproducible business improvement reports through high-dimensional feature extraction and automatic classification/summarization by AI. Furthermore, by optimizing AI model parameters and algorithms, customization according to specific industries and organizational structures is easy, and rapid adaptation is possible when deploying to other companies. Application fields include call centers, customer support, internal help desks, quality management departments, and even inquiry response operations in medical institutions and public organizations, and can be applied to a wide range of business improvement domains. Unlike conventional human work or simple rule-based processing, the system realizes improvement of computer technology itself through high-dimensional feature extraction in vector space, nonlinear pattern recognition by deep learning models, and integrated analysis of multiple data sources. This enables automation and optimization of the entire information extraction, organization, and report generation process for business improvement, strongly supporting organizational decision-making.

Step 1: The collection unit collects communication data. Communication data includes emails, chats, and call center histories. The collection unit acquires data from internal communication databases and automatically collects necessary information from various data sources using generative AI. For example, the collection unit acquires email data from mail servers, chat histories from chat applications, and call records from call center systems. Step 2: The analysis unit analyzes the communication data collected by the collection unit using generative AI. The analysis unit analyzes text in the data using natural language processing technology and extracts issues. For example, the analysis unit identifies information useful for business improvement, such as complaints from customers and feedback from employees. Step 3: The verbalization unit verbalizes the issues extracted by the analysis unit using generative AI. The verbalization unit organizes the extracted information and outputs the issues in an easily understandable manner as a report. For example, the verbalization unit generates a report summarizing complaint details from customers or improvement proposals from employees. Specifically, the processing flow in Example of the present invention is configured as a multi-stage AI pipeline in which the collection unit, analysis unit, and verbalization unit modules operate in cooperation. First, the system automatically acquires communication data from multiple data sources such as mail servers, chat servers, and call center record databases via the collection unit. When acquiring data, the collection unit vectorizes the communication data and stores it as structured data (e.g., a 4-dimensional vector consisting of sender, recipient, subject, and body for emails). Chat histories and call center histories are similarly managed as multidimensional arrays including sender, recipient, utterance content, timestamp, etc. The collection unit also automatically performs preprocessing such as duplicate elimination and noise removal to ensure data quality. Next, the analysis unit receives the structured data from the collection unit as input and inputs it into a natural language processing model (e.g., Transformer-based large language model). Examples of input include email body text (length 512 tokens), chat utterance sequences (time-series arrays, each utterance 100 tokens), and call center call records (speech recognition result text, 1000 tokens). The analysis unit applies morphological analysis, grammatical analysis, and semantic analysis in stages to generate features such as key phrase extraction, emotion analysis, and topic classification. For example, the analysis unit classifies the causes of complaints into categories such as “product defect”, “delayed response”, and “insufficient explanation”, and calculates occurrence frequency and impact scores (continuous values from 0.0 to 1.0) for each category. The output of the analysis unit is a list of extracted issues (e.g., {‘category’: ‘product defect’, ‘frequency’: 0.35, ‘representative sentence’: ‘product does not work’}), structured data with importance scores, or summary texts for each issue. The verbalization unit receives the output from the analysis unit and inputs it into a report generation model (e.g., encoder-decoder type generative model). The verbalization unit automatically generates reports in multiple expression formats such as bullet points, tables, and narrative summaries based on the list of extracted issues and summary texts. For example, it outputs specific sentences such as “The main causes of customer complaints are product defects (35%), delayed response (20%), and insufficient explanation (15%). Improvement proposals include enhancement of FAQs and revision of response manuals.” The output format can support various formats such as PDF, HTML, and CSV. Examples of AI input and output include input such as “Customer complaint email body (e.g., ‘Your product does not work. I contacted support but the response was slow.’)” or “Employee feedback (e.g., ‘Please consider introducing a new tool’)”, and output such as “Issue category: delayed response, importance: 0.8” or “Improvement proposal: consider tool introduction” as structured data or summary text. As subsequent processing, these outputs are used for dashboard display for management, automatic action plan generation, and linkage to KPI management systems. As a technical effect, the system can greatly improve processing speed and reduce variation in extraction accuracy compared to manual reading of large volumes of communication data by humans, and can stably generate highly reproducible business improvement reports through high-dimensional feature extraction and automatic classification/summarization by AI. Furthermore, by optimizing AI model parameters and algorithms, customization according to specific industries and organizational structures is easy, and rapid adaptation is possible when deploying to other companies. Application fields include call centers, customer support, internal help desks, quality management departments, and even inquiry response operations in medical institutions and public organizations, and can be applied to a wide range of business improvement domains. Unlike conventional human work or simple rule-based processing, the system realizes improvement of computer technology itself through high-dimensional feature extraction in vector space, nonlinear pattern recognition by deep learning models, and integrated analysis of multiple data sources. This enables automation and optimization of the entire information extraction, organization, and report generation process for business improvement, strongly supporting organizational decision-making.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned collection unit, analysis unit, and verbalization unit is implemented by at least one of, for example, the smart device 14 and the data processing apparatus 12. For example, the collection unit collects communication data such as emails, chats, and call center histories using the communication I/F 44 of the smart device 14. The analysis unit is implemented, for example, by a specific processing unit 290 of the data processing apparatus 12, analyzes the collected data using natural language processing technology, and extracts issues. The verbalization unit is implemented, for example, by the specific processing unit 290 of the data processing apparatus 12, verbalizes the extracted issues, and outputs them as a report. The correspondence between each unit and the apparatus or control unit is not limited to the examples described above, and various modifications are possible.

### Second Embodiment

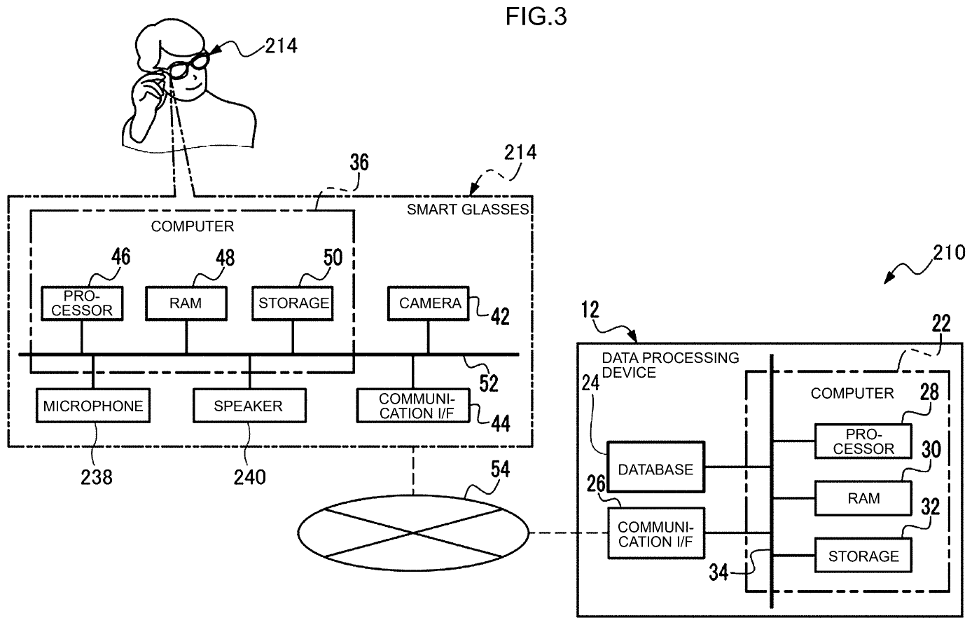

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

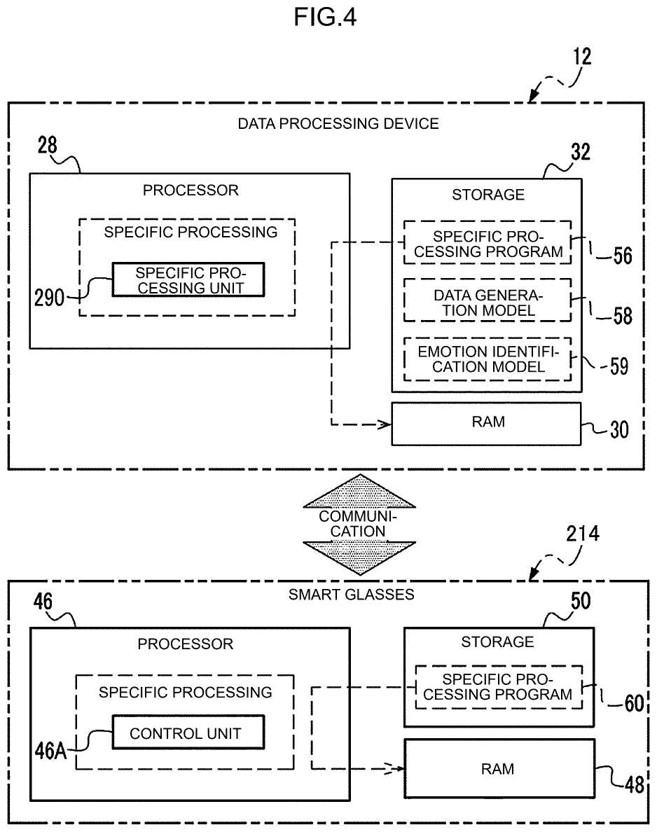

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned collection unit, analysis unit, and verbalization unit is implemented by at least one of, for example, the smart glasses 214 and the data processing apparatus 12. For example, the collection unit collects communication data such as emails, chats, and call center histories using the communication I/F 44 of the smart glasses 214. The analysis unit is implemented, for example, by a specific processing unit 290 of the data processing apparatus 12, analyzes the collected data using natural language processing technology, and extracts issues. The verbalization unit is implemented, for example, by the specific processing unit 290 of the data processing apparatus 12, verbalizes the extracted issues, and outputs them as a report. The correspondence between each unit and the apparatus or control unit is not limited to the examples described above, and various modifications are possible.

### Third Embodiment

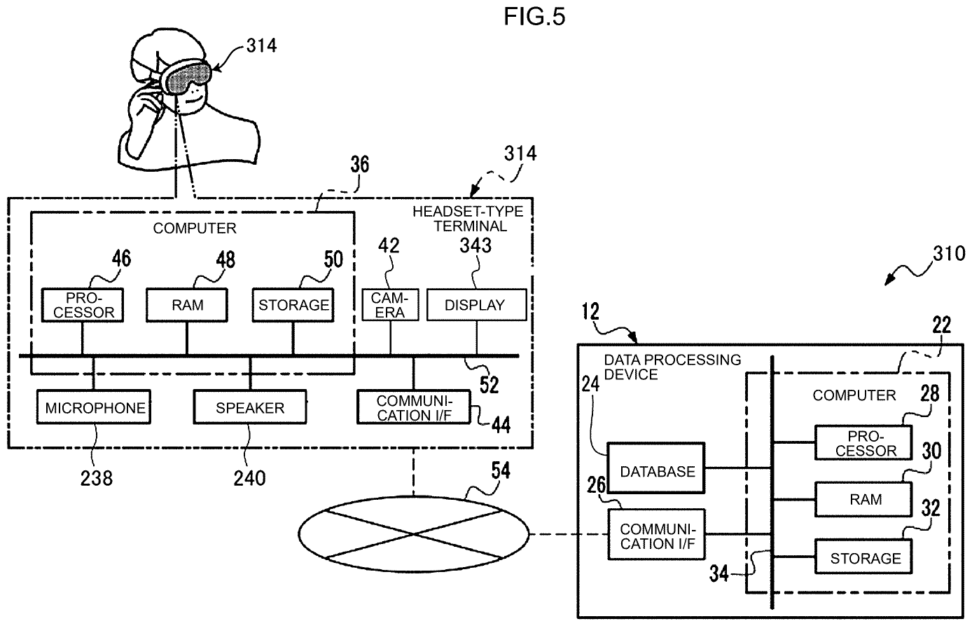

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

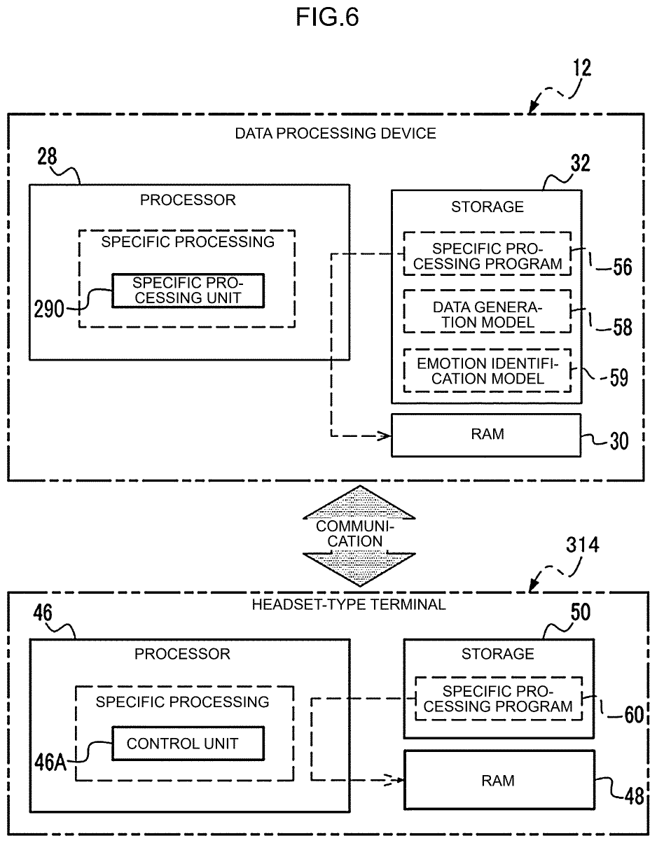

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned collection unit, analysis unit, and verbalization unit is implemented by at least one of, for example, the headset-type terminal 314 and the data processing apparatus 12. For example, the collection unit collects communication data such as emails, chats, and call center histories using the communication I/F 44 of the headset-type terminal 314. The analysis unit is implemented, for example, by a specific processing unit 290 of the data processing apparatus 12, analyzes the collected data using natural language processing technology, and extracts issues. The verbalization unit is implemented, for example, by the specific processing unit 290 of the data processing apparatus 12, verbalizes the extracted issues, and outputs them as a report. The correspondence between each unit and the apparatus or control unit is not limited to the examples described above, and various modifications are possible.

### Fourth Embodiment

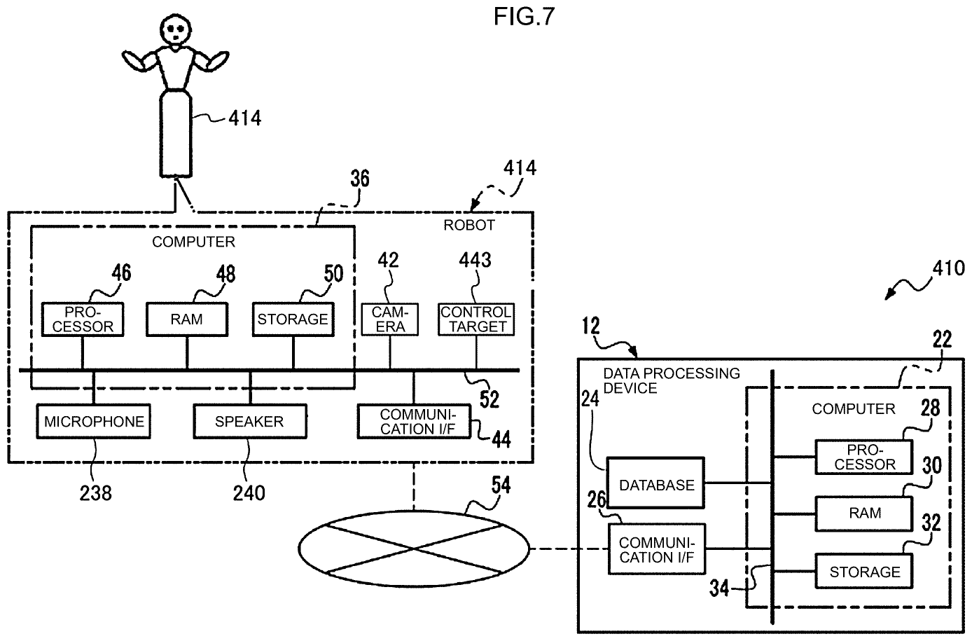

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

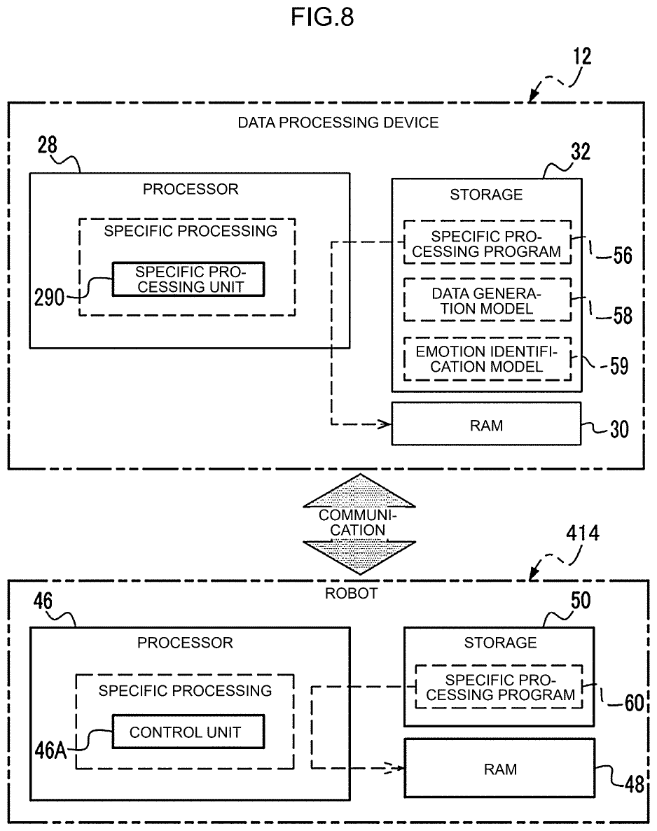

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned collection unit, analysis unit, and verbalization unit is implemented by at least one of, for example, the robot 414 and the data processing apparatus 12. For example, the collection unit collects communication data such as emails, chats, and call center histories using the communication I/F 44 of the robot 414. The analysis unit is implemented, for example, by a specific processing unit 290 of the data processing apparatus 12, analyzes the collected data using natural language processing technology, and extracts issues. The verbalization unit is implemented, for example, by the specific processing unit 290 of the data processing apparatus 12, verbalizes the extracted issues, and outputs them as a report. The correspondence between each unit and the apparatus or control unit is not limited to the examples described above, and various modifications are possible.

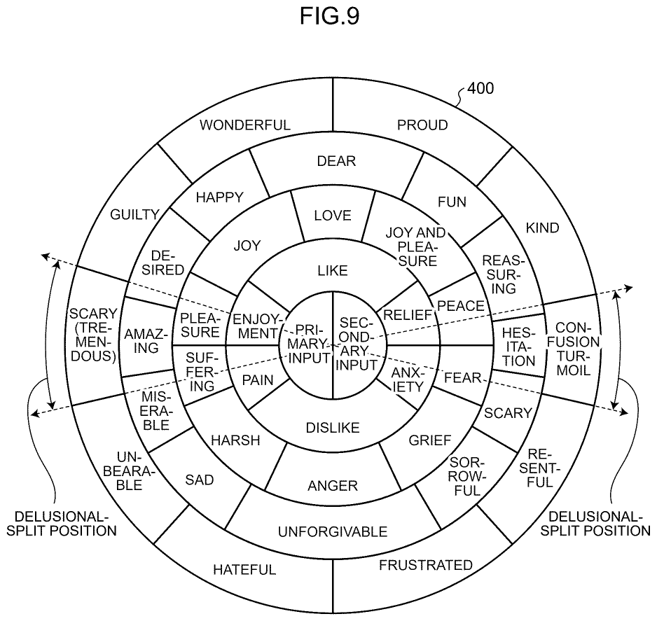

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

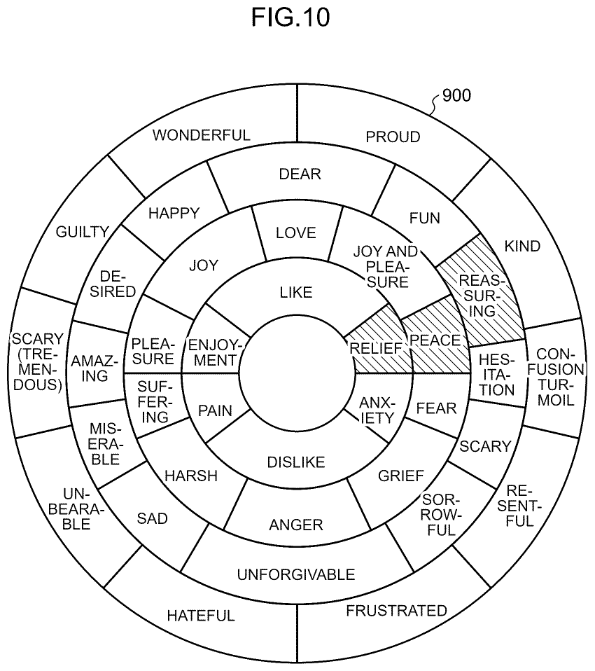

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a collection unit configured to collect communication data; an analysis unit configured to analyze the communication data collected by the collection unit and extract issues; and a verbalization unit configured to verbalize the issues extracted by the analysis unit.

(Supplementary Note 2) The system according to Supplementary Note 1, wherein the collection unit is configured to collect data of emails, chats, and call center histories.

(Supplementary Note 3) The system according to Supplementary Note 1, wherein the analysis unit is configured to analyze text in the data and extract issues using natural language processing technology.

(Supplementary Note 4) The system according to Supplementary Note 1, wherein the verbalization unit is configured to organize the extracted information in an easily understandable manner and output it as a report.

(Supplementary Note 5) The system according to Supplementary Note 1, wherein the verbalization unit is configured to generate a report summarizing complaint details from customers or improvement proposals from employees.

(Supplementary Note 6) The system according to Supplementary Note 1, wherein the analysis unit is configured to identify at least one of information useful for business improvement from complaints from customers or feedback from employees.

(Supplementary Note 7) The system according to Supplementary Note 1, wherein the collection unit is configured to estimate a user's emotion and adjust the timing of communication data collection based on the estimated emotion of the user.

(Supplementary Note 8) The system according to Supplementary Note 1, wherein the collection unit is configured to analyze a user's past communication data collection history and select an optimal collection method.

(Supplementary Note 9) The system according to Supplementary Note 1, wherein the collection unit is configured to perform filtering based on the user's current project or area of interest when collecting communication data.

(Supplementary Note 10) The system according to Supplementary Note 1, wherein the collection unit is configured to estimate a user's emotion and determine the priority of communication data to be collected based on the estimated emotion of the user.

(Supplementary Note 11) The system according to Supplementary Note 1, wherein the collection unit is configured to preferentially collect highly relevant data based on the user's geographic location information when collecting communication data.

(Supplementary Note 12) The system according to Supplementary Note 1, wherein the collection unit is configured to analyze the user's social media activity and collect relevant data when collecting communication data.

(Supplementary Note 13) The system according to Supplementary Note 1, wherein the analysis unit is configured to estimate a user's emotion and adjust the manner of analysis expression based on the estimated emotion of the user.

(Supplementary Note 14) The system according to Supplementary Note 1, wherein the analysis unit is configured to adjust the level of detail of analysis based on the importance of the communication data during analysis.

(Supplementary Note 15) The system according to Supplementary Note 1, wherein the analysis unit is configured to apply different analysis algorithms according to the category of the communication data during analysis.

(Supplementary Note 16) The system according to Supplementary Note 1, wherein the analysis unit is configured to estimate a user's emotion and adjust the length of analysis based on the estimated emotion of the user.

(Supplementary Note 17) The system according to Supplementary Note 1, wherein the analysis unit is configured to determine the priority of analysis based on the submission timing of the communication data during analysis.

(Supplementary Note 18) The system according to Supplementary Note 1, wherein the analysis unit is configured to adjust the order of analysis based on the relevance of the communication data during analysis.

(Supplementary Note 19) The system according to Supplementary Note 1, wherein the verbalization unit is configured to estimate a user's emotion and adjust the method of verbalization based on the estimated emotion of the user.

(Supplementary Note 20) The system according to Supplementary Note 1, wherein the verbalization unit is configured to adjust the level of detail of verbalization based on the importance of the extracted issues during verbalization.

(Supplementary Note 21) The system according to Supplementary Note 1, wherein the verbalization unit is configured to apply different verbalization algorithms according to the category of the extracted issues during verbalization.

(Supplementary Note 22) The system according to Supplementary Note 1, wherein the verbalization unit is configured to estimate a user's emotion and determine the priority of verbalization based on the estimated emotion of the user.

(Supplementary Note 23) The system according to Supplementary Note 1, wherein the verbalization unit is configured to adjust the order of verbalization based on the submission timing of the extracted issues during verbalization.

(Supplementary Note 24) The system according to Supplementary Note 1, wherein the verbalization unit is configured to adjust the order of verbalization based on the relevance of the extracted issues during verbalization.

What is claimed is:

1. A system comprising:
circuitry configured to:
acquire communication data from a plurality of data sources;
apply natural language processing to the communication data to extract structured issue data, wherein applying natural language processing comprises performing morphological analysis, grammatical analysis, and semantic analysis on the communication data; and
generate verbalized output based on the structured issue data.

2. The system according to claim 1, wherein the communication data comprises at least one of email data, chat data, or call center history data.

3. The system according to claim 1, wherein extracting the structured issue data comprises classifying the communication data into issue categories and calculating an importance score for each issue category.

4. The system according to claim 3, wherein the importance score is a continuous value from 0.0 to 1.0.

5. The system according to claim 1, wherein the circuitry is further configured to vectorize the communication data as multidimensional structured data prior to applying natural language processing.

6. The system according to claim 1, wherein generating the verbalized output comprises applying at least one of extractive summarization or generative summarization to the structured issue data.

7. The system according to claim 1, wherein the circuitry is further configured to estimate an emotion of a user based on the communication data, and wherein the circuitry adjusts a timing of acquiring the communication data based on the estimated emotion.

8. The system according to claim 7, wherein estimating the emotion comprises inputting the communication data into an emotion identification model that outputs an emotion classification and an emotion intensity score.

9. The system according to claim 1, wherein the circuitry is further configured to estimate an emotion of a user and determine a priority of applying the natural language processing based on the estimated emotion.

10. The system according to claim 1, wherein the circuitry is further configured to estimate an emotion of a user and adjust a level of detail of the verbalized output based on the estimated emotion.

11. The system according to claim 1, wherein the circuitry is further configured to acquire geographic location information of a user and preferentially acquire communication data having a relevance score above a threshold based on the geographic location information.

12. The system according to claim 1, wherein the circuitry is further configured to filter the communication data based on a current project or area of interest of a user prior to applying the natural language processing.

13. The system according to claim 1, wherein the circuitry is further configured to adjust a level of detail of applying the natural language processing based on an importance of the communication data.

14. The system according to claim 1, wherein the circuitry is further configured to apply different natural language processing algorithms according to a category of the communication data.

15. The system according to claim 1, wherein generating the verbalized output comprises generating at least one of bullet point formatted output, table formatted output, or narrative summary output.

16. The system according to claim 1, wherein the circuitry is further configured to adjust a level of detail of the verbalized output based on an importance score associated with the structured issue data.

17. The system according to claim 1, wherein the circuitry is further configured to apply different verbalization algorithms according to a category of the structured issue data.

18. A system comprising:
a communication interface configured to communicate with a plurality of data sources over a network;
a processor;
a random access memory;
a memory storing a data generation model and an emotion identification model; and
circuitry configured to:
acquire, via the communication interface, communication data from the plurality of data sources, wherein the communication data comprises at least one of email data, chat data, or call center history data;
vectorize the communication data as multidimensional structured data;
apply, using the data generation model, natural language processing to the multidimensional structured data to extract structured issue data, wherein applying natural language processing comprises performing morphological analysis, grammatical analysis, and semantic analysis;
estimate, using the emotion identification model, an emotion of a user based on the communication data;
adjust at least one of a timing of acquiring the communication data, a priority of applying the natural language processing, or a level of detail of verbalized output based on the estimated emotion; and
generate the verbalized output based on the structured issue data.

19. The system according to claim 18, wherein the structured issue data comprises issue categories, importance scores, and representative sentences, and wherein generating the verbalized output comprises generating a report summarizing complaint details or improvement proposals.

20. A method performed by circuitry of a system, the method comprising:
acquiring communication data from a plurality of data sources;
applying natural language processing to the communication data to extract structured issue data, wherein applying natural language processing comprises performing morphological analysis, grammatical analysis, and semantic analysis on the communication data; and
generating verbalized output based on the structured issue data.
